(19) United States
(12) Patent Application Publication
(10) Pub. No.: US 2018/0371630 A1
(43) Pub. Date: Dec. 27, 2018

(54) HIGH PRESSURE ELECTROCHEMICAL CELL

(71) Applicant: AquaHydrex Pty Ltd, North Wollongong (AU)

(72) Inventors: Gerhard Frederick SWIEGERS, North Wollongong (AU); Steven Duwayne KLOOS, Naperville, IL (US); Paul Brendan Denis Michael BARRETT, Woonona (AU)

(21) Appl. No.: 16/061,910

(22) PCT Filed: Dec. 14, 2016
(86) PCT No.: PCT/AU2016/051235

§ 371 Date: Jun. 13, 2018

(30) Foreign Application Priority Data
Dec. 14, 2015 (AU) 2015905154
Dec. 14, 2015 (AU) 2015905155
Dec. 14, 2015 (AU) 2015905156
Dec. 14, 2015 (AU) 2015905158
Dec. 14, 2015 (AU) 2015905160

(51) Int. Cl. C25B 11/03; C25B 1/04; C25B 15/08; C25B 9/06; C25B 9/18; H01M 2/20; H01M 4/94; H01M 4/86; H01M 8/04276

(52) U.S. Cl. CPC C25B 11/035; C25B 1/04; C25B 15/08; C25B 9/06; H01M 8/04276; H01M 2/202; H01M 4/94; H01M 4/8626; C25B 9/18

(57) ABSTRACT

Disclosed are electrochemical cells and methods of use or operation at high pressure, in which one or more gas-producing electrodes operate in a manner that is bubble-free or substantially bubble-free. Disclosed is a method for producing a gas in an electrochemical cell, and the electrochemical cell itself, wherein the electrochemical cell comprises a gas-producing electrode and a counter electrode being separated by an electrolyte. The method comprises creating an electrolyte pressure greater than or equal to 10 bar during operation of the electrochemical cell, and producing the gas wherein substantially no bubbles of the gas are formed at the gas-producing electrode. Preferably, there is no diaphragm or ion exchange membrane positioned between the gas-producing electrode and the counter electrode. In another example, the electrochemical cell is operated without a gas compressor. The gas-producing electrode and/or the counter electrode is a gas diffusion electrode.

### TECHNICAL FIELD

The present invention relates to the efficient or improved operation of electrochemical cells that involve a gas-liquid interface, particularly, but not exclusively, to the efficient or improved operation of gas-liquid electrochemical cells at high pressures.

### BACKGROUND

Numerous electrochemical cells facilitate liquid-to-gas or gas-to-liquid transformations that involve the formation of, or presence of gas bubbles in liquid electrolyte solutions. For example, electrochemical cells used in the chlor-alkali process typically generate chlorine gas and hydrogen gas in the form of bubbles at the anode and cathode, respectively.

Bubbles in an electrochemical cell generally have the effect of increasing the electrical energy required to undertake the chemical transformation in the cell. This arises from effects that include the following:
(1) Bubble formation: In order to create a bubble, supersaturated gas in the liquid electrolyte immediately adjacent to an electrode surface must combine to form a small bubble. The bubble is initially created by and held up by a large internal pressure (known as the ‘Laplace’ pressure). Such bubbles are typically very small and, since the Laplace pressure is inversely proportional to the internal pressure needed, they must necessarily contain high internal pressures of gas. For example, according to a thesis by Yannick De Strycker entitled “A bubble curtain model applied in chlorate electrolysis” (published by the Chalmers University of Technology, Goteborg, Sweden, in 2012), the hydrogen bubbles formed at the cathode in electrochemical chlorate manufacture at atmospheric pressure are estimated to initially be ca. 3.2 nm in diameter, so that their internal (‘Laplace’) pressures must be ca. 824 bar. The additional energy required to produce such bubbles is known in the art as the bubble overpotential. The bubble overpotential can be substantial. In the above-mentioned case, bubble formation by hydrogen at the cathode alone, was estimated to add ca. 0.1 V to the cell voltage. Once formed, the very small initial bubbles spontaneously expand as a result of their large internal pressure. In the above-mentioned case of hydrogen generation in chlorate manufacture at atmospheric pressure, the initial bubbles were found to expand to a diameter of ca. 0.1 mm, at which stage the pressure inside the bubble was equal to the pressure outside the bubble.
(2) “Bubble coverage”/“Bubble curtain”: Studies have shown that bubbles are typically formed in crevasses, clefts, or other micrometer- or nanometer-sized irregularities on electrode surfaces. This effect is driven by the fact that, according to the Laplace equation, the smaller the radius of a bubble, the higher the pressure inside the bubble must be to push the bubble up and to hold the bubble up. There is therefore a fundamental thermodynamic (energy) advantage to forming bubbles having small volumes but large radii. This can only occur within tiny crevasses, clefts or similar irregularities that may be present on many electrode surfaces. Bubbles formed within such features are not spherical but instead fill a portion—usually the deepest portion of the feature. Such bubbles have very small volumes. However, the bubbles formed in such features have large radii that extend along the length of the cleft or irregularity. The larger radii mean that the internal pressure of such bubbles may be very much lower than a spherical bubble of the same volume. Such ‘cleft’-based bubbles will therefore form at a lower level of electrolyte supersaturation with the gas in question, than will spherical bubbles. That is, the bubbles formed in such features, i.e. ‘cleft’-based bubbles, are favoured to form before spherical bubbles are formed on the electrode surface.
   ‘Cleft’-based bubbles of this type typically start within the ‘cleft’ feature on an electrode surface and then expand out of the cleft into a largely spherical shape. The resulting bubble is then held on the surface of the electrode by its attachment to the ‘cleft’ in which the bubble initially formed. The effect of having many such attached bubbles at the electrode surface is to create a bubble “curtain” between the liquid electrolyte and the active surface of the electrode. This “bubble curtain” (or “bubble coverage”) typically impedes movement of the electrolyte to the electrode surface, slowing or even halting the reaction. To overcome this effect, many electrochemical cells employ continuous mechanical pumping to sweep the electrolyte over the surface of the electrodes to dislodge surface bubbles. The resulting current drawn by the pump diminishes the overall electrical efficiency of the electrochemical cell.
(3) Bubbles in conduction pathway (“Voidage”): Even after bubbles are released from an electrode surface into the electrolyte they still impede electrical efficiency in a cell. In electrical terms, a bubble is a non-conducting void within the conduction pathway that comprises of the liquid electrolyte between the two electrodes. The greater the number of, and relative volume of such non-conducting voids present, the greater the overall electrical resistance of the cell. This effect, which is known in the art as “voidage”, becomes particularly pronounced as the current density increases, when larger volumes of bubbles are produced. In the above-mentioned example of chlorate manufacture, it has been estimated that, at high current densities, up to 60% of the space between the electrodes may be occupied by bubbles, increasing the cell voltage by ca. 0.6 V.

These issues can create undesirable effects in electrochemical cells in which gases are formed from liquids, or liquids are formed from gases. For example, water electrolyzers are devices that electrochemically convert water to hydrogen gas at the cathode and oxygen gas at the anode. A common class of this cell is an alkaline electrolyzer, which utilizes a strongly alkaline liquid electrolyte (typically 6 M KOH) between the cathode and anode. An ion-permeable, gas impermeable (or very slightly permeable) separator is typically required between the two electrodes to prevent bubbles of hydrogen formed at the cathode from mixing with bubbles of oxygen formed at the anode. To avoid or minimize the voidage and bubble-curtain effects, alkaline electrolyzers typically continuously pump the 6 M KOH electrolyte through the catholyte and anolyte chambers in order to sweep the gas bubbles away and keep the electrical conduction pathway between the anode and cathode as clear and void-free as possible. Despite these measures, however, conventional alkaline electrolyzers are typically operated only at current densities of less than ca. 300 mA/cm² (at potentials near 2 V), with system efficiencies near 60%. This compares with solid state proton exchange membrane (PEM) electrolyzers that typically operate at 1800 mA/cm², with efficiencies of up to 75% The low current densities in conventional alkaline electrolyzers arise because the cell resistance associated with the formation of increasing volumes of bubbles in the liquid electrolyte leads to diminishing and low energy efficiencies at higher current densities. Alkaline electrolyzers, in fact, do not even handle sudden increases in current density well, such as may be created by wind generators or solar panels. In the case of a very rapid rise in current, a large amount of gas may be quickly produced, creating a pressure burst hazard and potentially forcing the electrolyte out of the cell, thereby damaging the cell.

Conventional alkaline electrolyzers also do not operate at pressures higher than ca. 30 bar because the separator between the electrodes is not perfectly impermeable to gases. While high pressures have the effect of decreasing the size of the gas bubbles present (and thereby increasing the conductivity of the electrolyte), they also lead to microbubbles that can have the size of the pores in the separator. When such microbubbles lodge in the pores of the separator, they may create a gaseous pathway that facilitates and accelerates gas ‘crossover’, leading hydrogen to pass through the separator to contaminate the oxygen formed at the anode, and oxygen to pass through the separator to contaminate the hydrogen formed at the anode. If these trace amounts approach the lower or higher explosion limits of hydrogen in oxygen, then a safety issue may be created. As the applied pressure is increased, the rate of such crossover increases because the size of the bubbles gets smaller. The purity of the produced gases therefore decreases rapidly as the pressure is increased. Higher current densities at such higher applied pressures also create more bubbles, meaning that there is more chance of bubbles lodging in the separator, thereby increasing the rate of crossover. Thus, the purity of the produced gases decreases rapidly as the current density is increased at higher applied pressures.

By contrast, solid state proton exchange membrane (PEM) water electrolyzers have been developed that operate at pressures of up to 350 bar. However, as noted by the authors of the presentation for project PD117 in the 2015 Annual Merit Review Proceedings (Hydrogen Production and Delivery) of the US Department of Energy, even with PEM electrolyzers, it is generally “Not possible to have high efficiency at high pressures with current membranes”, since avoidance of crossover requires thicker membranes which provide greater electrical resistance to the current, thereby diminishing the electrical efficiency (very drastically at 350 bar).

Higher pressure alkaline electrolyzers have been developed by, for example, the US company Avalence LLC. Their system utilized specially designed, thick, separators with more rapid circulation of the electrolyte in the catholyte and anolyte chambers. However, even with the additional measures, this approach has been reported to be unviable beyond a pressure of 138 bar because of the great difficulty of equalising the differential pressure of the hydrogen and oxygen bubbles that are formed, a problem that is amplified at higher current densities (see pages 160-161 in the book “Hydrogen Production by Electrolysis”, by A. Godula-Jopek (Wiley-VCH, 2015)). Unless these pressures are maintained perfectly equal, a pressure gradient is created across the separator, which intensifies crossover, causing gas purities to become unsafe. International Patent Publication No. WO2013/066331 describes some of the measures employed by the electrolyzers of Avalence LLC.

A reason for the interest in high pressure electrolyzers arises from the fact that it is very much cheaper to pressurize the aqueous electrolyte in an electrochemical cell than it is to pressurize gases like hydrogen that are produced by such a cell. This is important because in the proposed future hydrogen economy, hydrogen-powered automobiles require hydrogen pressurised to 350-750 bar in order to conveniently carry hydrogen on a vehicle at an acceptable weight-to-volume ratio. At the present time, that level of compression can only be supplied by using hydrogen compressors that are extremely expensive and, more seriously, highly unreliable and prone to breakdown. If an electrolyzer could be developed that produced suitably high or ultra-high pressure hydrogen in an electrically efficient manner by pressurising a liquid electrolyte, then that would, effectively, eliminate what is today a key impediment to a future hydrogen economy.

In summary, there is a need to develop electrochemical cells and/or methods of operation capable of generating gases at high pressures, with improved electrical and energy efficiency, without the need for a gas compressor. Such a cell does not exist at present. There is similarly a need to develop electrochemical cells capable of utilizing gases at high pressures, with improved electrical and energy efficiency. As a result of these and other issues, new or improved cells, devices and/or methods of facilitating electrochemical transformations involving gases and liquids, or gels, and that avoid, ameliorate or diminish energy and electrical penalties are of interest.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY

This Summary is provided to introduce a selection of concepts in a simplified form that are further described below in the Examples. This Summary is not intended to identify all of the key features or essential features of the claimed subject matter, nor is it intended to be used to limit the scope of the claimed subject matter.

In one aspect there is provided a method for producing a gas in an electrochemical cell. The electrochemical cell comprises a gas-producing electrode and a counter electrode separated by an electrolyte. The method comprises creating, selecting or setting an electrolyte pressure during operation of the electrochemical cell, and producing the gas at the gas-producing electrode such that substantially no bubbles of the gas are formed at the gas-producing electrode.

In another aspect there is provided a method for producing a gas in an electrochemical cell, wherein the electrochemical cell comprises: a gas-producing electrode; and a counter electrode, the gas-producing electrode and the counter electrode being separated by an electrolyte, wherein the electrolyte is a liquid electrolyte or a gel electrolyte; wherein the method comprises: creating an electrolyte pressure greater than or equal to 10 bar during operation of the electrochemical cell; and producing the gas at the gas-producing electrode, wherein substantially no bubbles of the gas are formed at the gas-producing electrode.

In another aspect there is provided an electrochemical cell for producing a gas, wherein the electrochemical cell comprises: a gas-producing electrode; and a counter electrode, the gas-producing electrode and the counter electrode being separated by an electrolyte, wherein the electrolyte is a liquid electrolyte or a gel electrolyte; wherein there is no diaphragm or ion exchange membrane positioned between the gas-producing electrode and the counter electrode; and wherein the electrochemical cell operates at an electrolyte pressure greater than or equal to 10 bar and substantially no bubbles of the gas are formed at the gas-producing electrode.

In a preferred example, there is no diaphragm, separator or ion exchange membrane positioned between the gas-producing electrode and the counter electrode.

In another example aspect, the method includes selecting a current density at least partially based on an inter-electrode distance between the electrodes, to produce a crossover for the electrochemical cell. In one example, the current density is greater than or equal to 3 mA/cm², the inter-electrode distance is greater than or equal to 1 mm, and the crossover is less than or equal to 40%, 35%, 33%, 30%, 25%, 20%, 15%, 10%, 5% or 1%. In various other examples, the inter-electrode distance is greater than or equal to 3 mm, greater than or equal to 5 mm, greater than or equal to 10 mm, or greater than or equal to 25 mm.

In another example the electrochemical cell is operated without a gas compressor. In another example the gas-producing electrode is a gas diffusion electrode. In another example the counter electrode is a gas diffusion electrode. In another example the counter electrode produces a second gas and bubbles of the second gas are not formed or produced at the counter electrode, or the counter electrode is substantially free of bubble formation of the second gas. Preferably, the electrochemical cell is bubble-free, substantially bubble-free or substantially free of bubble formation during use. Preferably, the electrolyte is a liquid electrolyte or a gel electrolyte.

In example embodiments, “substantially free of bubble formation” or “substantially bubble-free” or “substantially no bubbles” means that less than 15% of the gas produced takes the form of bubbles in the electrolyte. In another example embodiment, less than 10% of the gas produced takes the form of bubbles in the electrolyte. In other example embodiments, less than 8%, less than 5%, less than 3%, less than 2%, less than 1%, less than 0.5%, or less than 0.25%, of the gas produced takes the form of bubbles in the electrolyte.

In a particular example the gas-producing electrode produces high purity gas having a purity of greater than or equal to 90%. In another particular example a current density of the electrochemical cell is greater than or equal to 50 mA/cm². In another particular example the gas-producing electrode and the counter electrode have a wetting pressure of greater than or equal to 0.2 bar. In another particular example an electrolyte replacement rate is less than 1 replacement of the electrolyte in the electrochemical cell volume every 1 hour.

In another example, the method further includes selecting (i.e. setting) an Inter-electrode Distance (ID) between the gas-producing electrode and the counter electrode and/or selecting a Current Density (CD) so that a Crossover (CO) for the electrochemical cell is less than or equal to 40%, or 35%, or 33%, or 30%, or 25%, or 20%, or 15%, or 10%, or 5%, or 1%, for example, wherein the Crossover (CO) is the percentage of the gas that crosses from the gas-producing electrode to the counter electrode due to gas migration in the electrolyte. Optionally, the Crossover (CO) is equal to or about 0%. In another particular example a Current Density (CD) is selected so that: an Electrolyte Factor (EF) is increased; a Power Density Factor (PF) is reduced; and a Crossover (CO) is reduced. In another example, the Inter-electrode Distance (ID) is selected or set and/or the Current Density (CD) is selected or set, to simultaneously reduce a Power Density Factor (PF).

### BRIEF DESCRIPTION OF THE FIGURES

Illustrative embodiments will now be described solely by way of non-limiting examples and with reference to the accompanying figures. Various example embodiments will be apparent from the following description, given by way of example only, of at least one preferred but non-limiting embodiment, described in connection with the accompanying figures.

FIG. 1 schematically depicts an example liquid-gas electrochemical cell that can be utilised in present embodiments (not to scale).

FIG. 2 schematically depicts the options available to gas formed at or near to the liquid-gas interface in an electrochemical cell.

FIG. 3 shows an example method for producing a gas in an electrochemical cell.

FIG. 4 shows modelling results from a model developed for an example water electrolyzer operating at a constant 1 bar pressure.

FIG. 5 depicts a 3D graph showing the conductivity of aqueous KOH electrolyte solution as a function of temperature and KOH concentration.

FIG. 6 shows modelling results from the model developed for an example water electrolyzer operating at various pressures.

FIG. 7 shows a graph of the calculated minimum purity of the hydrogen collected at the cathode as a function of the applied pressure and the KOH concentration when the current density is 50 mA/cm², the inter-electrode distance is 5 mm, and the temperature is 50° C.

FIG. 8 shows a graph of how the calculated minimum hydrogen purity varies up to 300 bar for different KOH concentrations, when the current density is 50 mA/cm², the inter-electrode distance is 5 mm, and the temperature is 50° C.

FIG. 9 shows a graph of the calculated minimum purity of the oxygen collected at the anode, as a function of the applied pressure and the KOH concentration, when the current density is 50 mA/cm², the inter-electrode distance is 5 mm, and the temperature is 50° C.

FIG. 10 shows a graph of how the calculated minimum oxygen purity varies up to 300 bar for different KOH concentrations, when the current density is 50 mA/cm², the inter-electrode distance is 5 mm, and the temperature is 50° C.

FIG. 11 shows a graph of the calculated minimum purity of the hydrogen collected at the cathode as a function of the applied pressure and the temperature when the current density is 50 mA/cm², the inter-electrode distance is 5 mm, and the KOH concentration is 6 M.

FIG. 12 shows a graph of the calculated minimum purity of the oxygen collected at the anode as a function of the applied pressure and the temperature when the current density is 50 mA/cm², the inter-electrode distance is 5 mm, and the KOH concentration is 6 M.

FIG. 13 shows a graph of the calculated minimum purity of the hydrogen collected at the cathode as a function of the current density and the applied pressure when the temperature is 50° C., the inter-electrode distance is 5 mm, and the KOH concentration is 6 M.

FIG. 14 shows a graph of the calculated minimum purity of the oxygen collected at the anode as a function of the current density and the applied pressure when the temperature is 50° C., the inter-electrode distance is 5 mm, and the KOH concentration is 6 M.

FIG. 15 depicts empirically measured purities of gases produced by: (a)-(b) a spiral-wound water electrolyser cell, and (c)-(d) a series-connected water electrolyser cell, of the present embodiments.

### DETAILED DESCRIPTION AND EXAMPLES

The following modes, features or aspects, given by way of example only, are described in order to provide a more precise understanding of the subject matter of a preferred embodiment or embodiments.

### Example Electrochemical Cells and Methods of Operation

international Patent Publication No. WO2013/185170 for “Gas Permeable Electrodes and Electrochemical Cells” filed 11 Jun. 2013, is incorporated herein by reference, and describes gas diffusion electrodes, including various alkaline and acidic electrolyzers and including gas-producing electrodes, and aspects thereof, which can be spiral-wound or kept in “flat-sheet” format, and utilised in the present examples.

Further aspects and details of example cells, modules, structures and electrodes, including gas-producing electrodes, and methods of operation, that are incorporated herein by reference, and that can be utilised in the present examples are described in the Applicant's previously filed International Patent Publication No. WO2015/013766 for “Modular Electrochemical Cells” filed 30 Jul. 2014; the Applicant's previously filed International Patent Publication No. WO2015/013765 for “Composite Three-Dimensional Electrodes and Methods of Fabrication” filed 30 Jul. 2014; the Applicant's previously filed International Patent Publication No. WO2015/013767 for “Electro-Synthetic or Electro-Energy Cell With Gas Diffusion Electrode(s)” filed on 30 Jul. 2014; the Applicant's previously filed International Patent Publication No. WO2015/013764 for “Method and Electrochemical Cell for Managing Electrochemical Reactions” filed on 30 Jul. 2014; the Applicant's previously filed International Patent Publication No. WO2015/085369 for “Electrochemical Cells and Components Thereof” filed on 10 Dec. 2014; and in the Applicant's concurrent International Patent Applications entitled “Electrochemical cell and components thereof capable of operating at high current density” and “Electrochemical cell and components thereof capable of operating at high voltage”, filed on 14 Dec. 2016, which are all incorporated herein by reference.

The electrodes, electrochemical cells and/or methods of operation described in the above patent applications can be used in example embodiments.

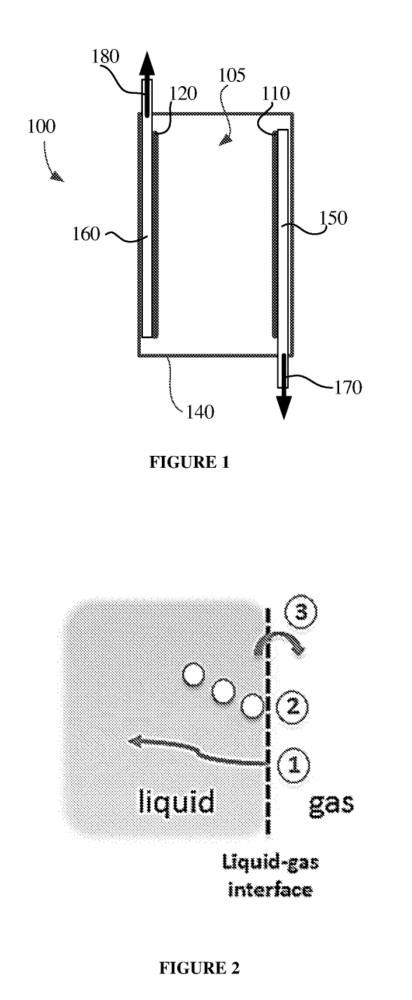

Referring to FIG. 1 there is illustrated a non-limiting example of an electrochemical cell 100. The electrochemical cell 100 includes an electrolyte 105, preferably a liquid electrolyte or a gel electrolyte that can be subjected to an electrolyte pressure, existing between and/or about anode 110 and cathode 120, i.e. electrodes 110, 120. The anode 110 can be a gas-producing electrode and/or the cathode 120 can be a gas-producing electrode. Either of the anode 110 or the cathode 120 can be termed a counter electrode respective to the other electrode. For example, there can be provided an electrode 110 and a counter electrode 120, or an electrode 120 and a counter electrode 110. Optionally, on, embedded in, or close to the surface of the electrodes 110, 120 is a conductive layer or region containing a suitable catalyst(s). Preferably, the electrode and catalyst layers at the anode 20 and cathode 30 are permeable to gases. The electrochemical cell 100 includes a housing or container 140 for containing electrolyte 105. First gas region, channel or conduit 150 is formed as part of, adjacent or next to anode 110, for collecting and/or transporting a first gas 170, if any, produced at anode 110. Second gas region, channel or conduit 160 is formed as part of, adjacent or next to cathode 120, for collecting and/or transporting a second gas 180, if any, produced at cathode 120. First gas region, channel or conduit 150 and second gas region, channel or conduit 160 can be provided separately or together in electrochemical cell 100. Depending on the particular reaction, first gas 170 and/or second gas 180 can be produced, and optionally transported out of electrochemical cell 100. The direction of gas exit is for illustration only and can be varied.

First gas region, channel or conduit 150 provides one example form of one or more void volumes, positioned at or adjacent to electrode 110. Second gas region, channel or conduit 160 also provides one example form of a separate one or more void volumes, positioned at or adjacent to electrode 120.

An electrical current, having a current density, is applied to the electrodes 110, 120, or a voltage can be applied across electrodes 110, 120, using an electrical power source. No bubbles, or substantially no bubbles, of first gas 170 and/or second gas 180 are formed at either the anode 110 or cathode 120 surfaces. That is, the electrochemical cell is substantially free of bubble formation, i.e. substantially bubble-free, at the anode and/or the cathode. This means that less than 15% of the gas formed or produced at the anode and/or the cathode takes the form of bubbles in the electrolyte. In a particular example, the anode 110 and/or cathode 120 can include a porous conductive material, which can be flexible. Preferably, the porous conductive material is gas permeable and liquid permeable (i.e. electrolyte permeable). The anode 110 and/or cathode 120 can include, or be next to, fixed to, or adjacent, a gas permeable material, which also can be flexible. Preferably, the gas permeable material is gas permeable and liquid impermeable (i.e. electrolyte impermeable), and thus the anode 110 and/or cathode 120 composite structure can be gas permeable and liquid impermeable (i.e. electrolyte impermeable), and optionally flexible. Preferably, the gas permeable material is non-conductive. The anode 110 and/or cathode 120 can be Gas Diffusion Electrodes (GDEs). In an optional example, electrolyte 105 can be pumped past the electrodes 110, 120 using a pump. In other example embodiments, less than 10% of the gas produced takes the form of bubbles in the electrolyte. In other example embodiments, less than 8%, less than 5%, less than 3%, less than 2%, less than 1%, less than 0.5%, or less than 0.25%, of the gas produced takes the form of bubbles in the electrolyte.

Reference to a gas permeable material should be read as a general reference including any form or type of gas permeable medium, article, layer, membrane, barrier, matrix, element or structure, or combination thereof.

Reference to a gas permeable material should also be read as including any medium, article, layer, membrane, barrier, matrix, element or structure that is penetrable to allow movement, transfer, penetration or transport of one or more gases through or across at least part of the material, medium, article, layer, membrane, barrier, matrix, element or structure (i.e. the gas permeable material). That is, a substance of which the gas permeable material is made may or may not be gas permeable itself, but the material, medium, article, layer, membrane, barrier, matrix, element or structure formed or made of, or at least partially formed or made of, the substance is gas permeable. The gas permeable material may be porous, may be a composite of at least one non-porous material and one porous material, or may be completely non-porous. The gas permeable material can also be referred to as a “breathable” material. By way of clarifying example only, without imposing any limitation, an example of a gas permeable material is a porous matrix, and an example of a substance from which the gas permeable material is made or formed is PTFE.

An electrode can be provided by or include a porous conductive material. Preferably, the porous conductive material is gas permeable and liquid permeable.

Reference to a porous conductive material should be read as including any medium, article, layer, membrane, barrier, matrix, element or structure that is penetrable to allow movement, transfer, penetration or transport of one or more gases and/or liquids through or across at least part of the material, medium, article, layer, membrane, barrier, matrix, element or structure (i.e. the porous conductive material). That is, a substance of which the porous conductive material is made may or may not be gas and/or liquid permeable itself, but the material, medium, article, layer, membrane, barrier, matrix, element or structure formed or made of, or at least partially formed or made of, the substance is gas and/or liquid permeable. The porous conductive material may be a composite material, for example composed of more than one type of conductive material, metallic material, or of a conductive or metallic material(s) and non-metallic material(s).

By way of clarifying examples only, without imposing any limitation, examples of porous conductive materials include porous or permeable metals, conductors, meshes, grids, lattices, cloths, woven or non-woven structures, webs or perforated sheets. The porous conductive material may also be a material that has “metal-like” properties of conduction. For example, a porous carbon cloth may be considered a porous conductive material since its conductive properties are similar to those of a metal.

The porous conductive material may be a composite material, for example composed of more than one type of conductive material, metallic material, or of a conductive or metallic material(s) and non-metallic material(s). Furthermore, the porous conductive material may be one or more metallic materials coated onto at least part of the gas permeable material, for example sputter coated, or coated or deposited onto at least part of a separate gas permeable material that is used in association with the gas permeable material. By way of clarifying examples only, without imposing any limitation, examples of porous conductive materials include porous or permeable metals, conductors, meshes, grids, lattices, cloths, woven or non-woven structures, webs or perforated sheets. The porous conductive material may be a separate material/layer attached to the gas permeable material, or may be formed on and/or as part of the gas permeable material (e.g. by coating or deposition).

The electrochemical cell can be provided in a “flat-sheet” (i.e. stacked) or a “spiral-wound” format. Flat-sheet means the electrodes (e.g. cathodes and/or anodes) are formed of planar layers or substantially planar layers, so that a flat-sheet electrochemical cell is comprised of a plurality of planar electrodes or substantially planar electrodes. A flat-sheet electrochemical cell can be stacked together with other flat-sheet electrochemical cells (one on top of another in a series or array of electrochemical cells) to form a layered stack of multiple electrochemical cells (i.e. a stacked electrochemical cell). The “flat-sheet” and “spiral-wound” cells, modules or reactors typically involve gas permeable, liquid impermeable gas diffusion electrode sheets or layers stacked in two or more layers, where the electrodes, including gas-producing electrodes, are separated from one another by spacers or spacer layers, for example distinct electrolyte channel spacers (which are permeable to, and intended to guide the permeation of liquid electrolyte through the cell) and/or gas channel spacers (which are permeable to, and intended to guide the permeation of gases through the cell). There may be more than one type of gas channel. For example, there may be two distinct gas channels, one for a first gas (e.g. hydrogen in a water electrolysis cell) and another for a second gas (e.g. oxygen in a water electrolysis cell). There may, similarly, be separate channels for more than one electrolyte. For example, in a modified chlor-alkali cell suitable for manufacturing chlorine—hypochlorite disinfection chemistries, there may be separate channels for the feed electrolyte (NaCl solution, 25%, pH 2-4) and the product electrolyte.

In the “spiral-wound” arrangement, the resulting multi-electrode stack is tightly wound about a core element, to thereby create the spiral-wound cell or module. The core element may contain some or all of the gas-liquid and electrical conduits with which to plumb and/or electrically connect the various components of the cell or module. For example, the core element may combine all of the channels for one or another particular gas in the stack into a single pipe, which is then conveniently valved for attachment to an external gas tank. The core element may similarly contain an electrical arrangement which connects the anodes and cathodes of the module into only two external electrical connections on the module a positive pole and a negative pole.

One key advantage of spiral-wound cells or modules over other module arrangements is that they provide a high overall electrochemical surface area within a relatively small overall geometric footprint. A spiral-wound electrochemical module is believed to provide for the highest possible active surface area within the smallest reasonable footprint. Another advantage of spiral-wound arrangements is that round objects are easier to pressurize than other geometries which involve corners. So, the spiral design has been found to be beneficial for electrochemical cells in which the electrochemical reaction is favourably impacted by the application of a high pressure.

Regardless of whether the reactor or cell arrangement is spiral wound or flat sheet the modular reactor units may be so engineered as to be readily attached to other identical modular units, to thereby seamlessly enlarge the overall reactor to the extent required. The combined modular units may themselves be housed within a second, robust housing that contains within it all of the liquid that is passed through the modular units and which serves as a second containment chamber for the gases that are present within the interconnected modules. The individual modular units within the second, outer robust housing may be readily and easily removed and exchanged for other, identical modules, allowing easy replacement of defective or poorly operational modules.

In an embodiment where the electrochemical cell contains at least one gas diffusion electrode, the cell preferably but not exclusively has one or more of the following advantages:
(1) an ability to conveniently and economically manage a variety of industrial electrochemical processes by deployment of gas diffusion electrodes where only solid-state electrodes had previously been viable or economical;
(2) an ability to apply higher gas or liquid pressures in electrochemical cells utilizing gas diffusion electrodes than had previously been possible;
(3) elimination of the need for complex and expensive pressure-equalising equipment in industrial electrochemical cells that currently employ gas diffusion electrodes. The pressure equalising equipment was needed to avoid substantive pressure differentials over the gas and the liquid sides of the gas diffusion electrodes, which would result in leaking of the liquid electrolyte;
(4) an ability to conveniently and economically facilitate energetically-favourable gas depolarization reactions at electrodes (for example at the counter electrode) in industrial electrochemical cells and/or devices, where this was attractive from an energy efficiency point of view but had not been previously feasible; and/or
(5) the possibility of adding a barrier layer or film to a gas diffusion electrode such that it permits transport of the reactant/product gas but excludes water vapour.

### Minimising Gas Solubility and Bubble Formation

In example embodiments, methods and cells for facilitating the operation of electrochemical cells by minimising gas solubility and bubble formation are described in the Applicant's concurrent International Patent Application for “Methods of improving the efficiency of gas-liquid electrochemical cells”, filed on 14 Dec. 2016, which is incorporated herein by reference.

The inventors have realised that in electrochemical cells involving a liquid or gel electrolyte between the electrodes, which are preferably one or more gas-producing electrodes, gas that may be formed or built up within the liquid electrolyte in the cell (for example, at the surface of an electrode in the cell) can do one of three things:
(1) The gas can dissolve in the liquid electrolyte and migrate away;
(2) The gas can form a new, independent bubble;
(3) The gas can join an existing bubble (or gas region), either natural or man-made. That is, the gas can pass across an existing gas-liquid interface into an existing gaseous phase or region.

FIG. 2 illustrates, in schematic form, the three different pathways 1, 2, 3, following the above numbering, available to gas formed within a liquid electrolyte in a gas-liquid cell.

Pathway (1) above is generally deleterious to energy efficiency, since the presence of dissolved gases in the liquid electrolyte between the electrodes of an electrochemical cell leads to higher electrical resistance, as taught in US 20080160357. It also promotes crossover between the electrodes.

For the reasons given in the Background section, pathway (2) above is generally also deleterious to the efficient operation of a cell having liquid or gel electrolyte between its electrodes.

The inventors have, contrary to known expectations, realised that pathway (3) above need not be deleterious to the efficient operation of a cell having liquid or gel electrolyte between the electrodes, if the “existing bubble” (i.e. “gas region” or “one or more void volumes”), either natural or man-made, lies outside of, or substantially outside of, the conduction pathway between the electrodes.

One or more “void volumes” can be provided by one or more porous structures, which can be provided by one or more gas permeable materials. The one or more porous structures, or gas permeable materials, providing one or more void volumes, are preferably gas permeable and liquid impermeable, or substantially liquid impermeable. The one or more porous structures, or gas permeable materials, providing one or more void volumes, are also preferably non-conducting.

The inventors have realised that, in fact, pathway (3) provides a potentially useful means of controlling and handling gas formation in a manner that ensures gas formation is not deleterious to the operation and efficiency of the cell. That is, the inventors have unexpectedly realised that instead of seeking to supress or block bubble formation, it may be more efficacious to direct gas formation to a pre-existing bubble or gas region (i.e. one or more void volumes), either natural or man-made, that has been designed to accept and accommodate gas formation in a way that does not impinge or substantially impinge on the operation and efficiency of the cell.

Moreover, the inventors have realised that, as a consequence of the Laplace equation, it is, in fact, energetically more favourable for newly formed or dissolved gas within a liquid to join a large, pre-existing bubble or gas region, either natural or man-made, than it is for the gas to form an independent, new bubble on a surface (either within a ‘cleft’ or as a stand-alone spherical bubble). This is because a large, pre-existing bubble (which could also be considered as a gas region or a void volume) will necessarily have a larger radius and therefore a lower internal (‘Laplace’) pressure than either a newly-formed spherical bubble or a newly-formed bubble in a surface ‘cleft’.

Furthermore, the concentration of dissolved gas within a liquid electrolyte is also necessarily minimised about a pre-existing bubble, gas region or void volume, either natural or man-made, since the bubble, region or volume provides an additional interface through which excess gaseous molecules are favoured to escape the liquid phase. In particular, it is, effectively, impossible for a liquid electrolyte to become supersaturated near to such a bubble, since the bubble interface provides a ready route for the excess gas to escape the liquid phase. This is important because the lower the quantity of dissolved gases in the liquid electrolyte, the lower its electrical resistance and the greater the energy/electrical efficiency of the cell, whilst crossover is also supressed.

Thus, in particular example embodiments, the inventors have realised that providing one or more void volumes, e.g. a pre-existing bubble, gas region or gas pathway, either naturally occurring or man-made, that is preferably positioned outside of the electrical conduction pathway between a gas-producing electrode and its counter electrode, substantially outside of the electrical conduction pathway between a gas-producing electrode and its counter electrode, partially outside of the electrical conduction pathway between a gas-producing electrode and its counter electrode, peripheral to or adjacent to the electrical conduction pathway between a gas-producing electrode and its counter electrode, and/or having a small cross-sectional area relative to the electrical conduction pathway between a gas-producing electrode and its counter electrode, and which can be within, partially within, adjacent to or near to a liquid electrolyte, or gel electrolyte, between a gas-producing electrode and its counter electrode of a cell, has the effect of not only disfavouring pathway (2) above but also minimising pathway (1) above. In another example, the counter electrode is a gas-producing counter electrode, so that both of the electrodes are gas-producing electrodes.

In particular example embodiments, the inventors have, further, discovered that pathway (1) above may be further lessened by selecting physical conditions for the cell that diminish, reduce, or minimise the dissolution of gases and/or their diffusion in the liquid electrolyte under conditions of high, higher, or maximal electrolyte conductivity. Stated differently: in particular example embodiments, the inventors have discovered that the deleterious effect of pathway (1) on the cell may be further lessened by configuring or selecting physical conditions for the cell that diminish, reduce, or minimise the effect that dissolved gases may have on the operation of the cell under conditions of high, higher, or maximal energy efficiency. The physical conditions include but are not limited to, one or more of the following:
a. The temperature of operation;
b. The type and concentration of the electrolyte in the liquid phase (including the surface tension of the electrolyte);
c. The pressure applied to the liquid electrolyte (including the pressure differential across a gas diffusion electrode that may be used);
d. The nature of any spacer that may be used to separate the electrodes;
e. The mode of operation;
f. The flow-rate of the liquid electrolyte; and
g. The flow-type of the liquid electrolyte (i.e. laminar or turbulent flow).

In particular example embodiments, the inventors have found that it can be beneficial to use physical laws such as Ficks' law, Henry's law, Raoults' law, the Senechov equation, the Stokes-Einstein (-Sutherland) equation, and similar expressions, to guide the setting of the above physical conditions. It may be useful to thereafter further refine the settings for the physical conditions using empirical measurement.

In particular example embodiments, the inventors have found that, in general and without limitation, the physical conditions within the cell should be configured or selected so as to:
(I) increase or maximise the electrical conductance of the electrolyte (typically, but not exclusively in units of S/cm) to the greatest reasonable extent,
(II) whilst simultaneously reducing or minimising the dissolution of gases in the electrolyte (typically, but not exclusively in units of mol/L) to the greatest reasonable extent, and
(III) reducing or minimising the rate of diffusion of the dissolved gas or gases in the electrolyte (typically, but not exclusively in units of cm²/s) to the greatest reasonable extent.

For convenience, (I) above is referred to as the “Conduction Factor” and given the symbol CF. In general, the physical conditions employed within the cell should be such that CF (typically, but not exclusively in units of S/cm) is increased or maximised to the greatest reasonable extent. The conductance, or conductivity of the electrolyte, is the reciprocal of electrical resistivity (in Ω cm—ohm centimeters). Therefore the Conduction Factor, or conductivity, is used as a measure the ionic conductance of the electrolyte. The unit of measurement used is typically, but not exclusively a Siemen per centimetre (S/cm).

For convenience, the product of (II) multiplied by (III) above is referred to as the “Gas Dissolution and Diffusion Factor” and given the symbol GDDF. In particular example embodiments, the inventors have found that, in general and without limitation, the physical conditions employed within the cell should be such that GDDF (typically, but not exclusively in units of: cm²·mol/L·s) is reduced or minimised to the greatest reasonable extent. Where multiple gases are involved, the sum of their GDDF's should be minimised to the greatest reasonable extent.

The expression for GDDF derives from Ficks' law for diffusion of dissolved gases in a liquid phase, and reflects the influence that diffusing, dissolved gases may have on the chemical processes present in an electrochemical cell of present embodiments. The lower GDDF is, the less influence dissolved gases may have. That is, the lower GDDF is, the smaller is the effect of pathway (1) above, or the smaller is the influence of pathway (1) above on the chemical reactions in an electrochemical cell of present embodiments.

For convenience, the ratio of CF divided by GDDF is referred to as the “Electrolyte Factor” and given the symbol EF. In general and without limitation, in particular example embodiments, the inventors have found that the physical conditions employed within the cell should be such that EF (typically, but not exclusively in units of: L·s/Ω cm³ mol) is increased or maximised to the greatest extent reasonable.

The expression EF=CF/GDDF reflects the ratio of the electrically conductive capacity of the liquid electrolyte to the extent of gas dissolution and diffusion in the liquid electrolyte. As noted above, in particular example embodiments, the inventors have found that certain electrochemical cells operate most efficiently if the electrical conductance of the liquid electrolyte is increased or maximised whilst simultaneously the extent of gas dissolution and diffusion in the liquid electrolyte is reduced or minimised.

Once the above combination of factors have been realised by setting the physical conditions in the most suitable, or least compromised manner, then features of the electrochemical cell design may be altered, set, created, or implemented to realise additional energy efficiencies. The electrochemical cell design features include but are not limited to, one or more of the following:
a. The inter-electrode distance employed;
b. The current density employed.

For convenience, the Inter-electrode Distance (typically, but not exclusively in units of: cm) is given the symbol ID, while the Current Density (typically, but not exclusively in units of: mA/cm²) is given the symbol CD.

In particular example embodiments, the inventors have found that, in general and without limitation, the features of design within the cell, namely: the Inter-electrode Distance (ID, typically, but not exclusively in units of: cm) and the Current Density (CD, typically, but not exclusively in units of: mA/cm²) should be set such that the product of the square of CD multiplied by ID (typically, but not exclusively in units of: cm) and divided by CF (typically, but not exclusively in units of: S/cm), is reduced or minimized to the greatest reasonable extent. For convenience, this expression, ((CD)²×ID)/CF), is referred to as the “Power Density Factor” and given the symbol PF (typically, but not exclusively in units of mA²·Ω/cm²). In general and without limitation, the physical conditions employed within the cell should be such that PF is reduced or minimized to the greatest reasonable extent.

Thus, the Power Density Factor (PF) is given by:

PF=((CD)²×ID)/CF.

The Power Density Factor (PF) is related to the rate at which work must be done to push an electrical current between the electrodes in the electrochemical cell—i.e. the electrical power consumed per unit area of gas-producing electrode. An increased energy and electrical efficiency in the cell must necessarily be accompanied by a reduction or minimization in the rate of work that must be done to drive an electric current between the electrodes in the cell. The quantity PF is therefore a proxy for, and inversely related to the energy efficiency of the cell.

In particular example embodiments, the inventors have found that it is also useful to quantify the percentage of the gases generated in an electro-synthetic cell of present embodiments, that crossover from one electrode to the other due to gas migration in the liquid electrolyte. This Crossover quantity, CO, as a percentage, is provided by the expression for Crossover (CO):

CO=(n·F·GDDF)/(ID·CD)×100 (in units of: %)

where,
n=the number of electrons exchanged in the balanced, electrochemical half-reaction occurring at the gas-producing electrode in question (i.e. the number of electrons in the balanced redox half-reaction),
F=the Faraday constant=96,485 Coulombs/mol,
GDDF=Gas Dissolution and Diffusion Factor, which equates to:
   =(concentration of dissolved gas [in units of: mol/L])×(rate of diffusion of the dissolved gas [in units of: cm²/s]
      (in overall units of: cm²·mol/L·s,
      which can also be expressed as: mol/(1000 cm s),
         ID=the inter-electrode distance (in units of: cm),
         CD=the current density (in units of: mA/cm²), and
where the individual factors in the above equation have the following units:
   (n·F·GDDF) has units: C·cm²/L·s,
      which can also be expressed as: C (1000 cm s),
      which can also be expressed as: mA/cm
   (n·F·GDDF)/ID has units: mA/cm²
   CD has units: mA/cm²
   (n·F·GDDF)/(ID·CD)×100 has units: %

In particular example embodiments, the inventors have found that, in general and without limitation, substantial energy efficiencies which may be greater than those achievable using other approaches, can be realised in electrochemical cells if the physical conditions in the cell and the features of cell design within the cell are set so that:
The Electrolyte Factor, EF (in units of: L·s/Ω cm³ mol), is increased or maximised to the greatest reasonable extent;
The Power Density Factor, PF (in units of: mA²/cm²), is reduced or minimized to the greatest reasonable extent; and
The Crossover, CO (in %), is reduced or minimized to the greatest reasonable extent.

Taking all of the above into account, in particular example embodiments, the inventors further realised that when the effect of a careful selection of the physical conditions and the cell design features as described above, are combined with the effect of providing an existing bubble or gas region, i.e. one or more void volumes, either natural or man-made, that lies outside of, or substantially outside of the electrical conduction pathway, or positioned to have only a small or minimal effect between the electrical conduction pathway, then significant improvements in energy efficiencies are achieved in the electrochemical cell. These energy efficiencies may be greater than those achievable using other approaches, such as the use of solid-state ion-exchange membranes between the electrodes.

| | | Voltage drop | |
|---|---|---|---|
| | | between the | |
| | | electrodes under | |
| Type of liquid-gas electrochemical | | typical operating | |
| cell | Example | conditions* | |
| Cell with liquid electrolyte where gas | Conventional | up to 0.600 | V |
| is generated in the form of bubbles | alkaline | | |
| | electrolyzer | | |
| Cell with a solid-state, ion-exchange | PEM | 0.229 | V |
| membrane electrolyte, where gas is | electrolyzer | | |
| generated in the form of vapour | | | |
| Cell with liquid electrolyte where gas | Alkaline | 0.011 | V |
| joins a pre-existing bubble/gas region | electrolyzer of | | |
| outside of the conduction pathway | present | | |
| | embodiments | | |

*data from Example 2

Table 1 compares the ohmic voltage drop that occurs during typical operation of a conventional alkaline electrolyzer, a PEM electrolyzer and an electrolyzer of present embodiments.

Thus, for example, as noted in Table 1: an electrochemical cell in which gas is produced in the form of bubbles, such as a conventional alkaline electrolyzer, may experience a typical voltage drop of up to 0.6 V between the electrodes under operational conditions due to the effect of bubbles in the liquid electrolyte.

By contrast, a conventional PEM electrolyzer utilizing a solid-state Nafion 117 PEM membrane (185 μm thickness; immersed in water) between the electrodes and operating at a typical current density of 1.8 A/cm² at 80° C. will experience a much smaller 0.229 V ohmic drop between the electrodes.

Best of all, however, is an alkaline electrolyzer of current embodiments having a 3 mm inter-electrode gap and operating at a typical current density of 50 mA/cm² at 80° C. using aqueous 6 M KOH as a liquid electrolyte. Such an electrolyzer will experience a mere 0.011 V ohmic drop between the electrodes. A low voltage drop is consistent with high, or higher fundamental energy and electrical efficiency.

It should be noted that, even if the PEM electrolyzer of the above example were to be operated at one-twentieth of its normal, operational current density (i.e. at 90 mA/cm²), which would likely be economically unviable, it would still experience a higher voltage drop than that experienced by the above alkaline electrolyzer.

Summarising these concepts, embodiments involve electrochemical cells and methods of use or operation in which one or more gas-producing electrodes operate in a manner that is bubble-free or substantially bubble-free. The electrochemical cell does not have a diaphragm present between the gas-producing electrodes. Preferably, the electrochemical cell makes use of a particular catalyst-electrolyte system. The electrochemical cell is optimised to determine the best settings for different variables of the electrochemical cell, including:
(i) the electrolyte concentration (e.g. KOH concentration in one example);
(ii) the temperature of the electrolyte;
(iii) the pressure applied to the electrolyte;
(iv) the inter-electrode distance (e.g. the distance between the anode and the cathode); and
(v) the current density.
   For optimisation of the electrochemical cell, it is required to determine what settings for these variables yield the optimum performance by a gas-producing electrode of the electrochemical cell.

There are three main relationships between these variables that are believed to be critical to optimising electrode performance; these are, as described above: the Electrolyte Factor (EF), the Power Density Factor (PF) and the Crossover (CO). The maximum or optimal electrode performance occurs when the following conditions are simultaneously met: EF is maximised, PF is minimised and CO is minimised.

Not only may the energy efficiencies realised by this approach be more substantial than those achievable using other approaches, such as the use of solid-state ion-exchange membranes between the electrodes, but they may also be most amplified under circumstances where energy losses are normally at their greatest in conventional cells; that is, at higher pressures and/or current densities.

Of the five different variables (i)-(v) listed above, three are physical reaction aspects—namely, (i) the electrolyte concentration, (ii) the temperature, and (iii) the pressure. However, the other two variables are, effectively, engineering quantities and can be set from wide ranges for satisfying or improving optimisation, namely: (iv) the inter-electrode distance, and (v) the current density.

That is important because the Electrolyte Factor (EF) is determined only by variables (i)-(iii) above, i.e. (i) the electrolyte concentration, (ii) the temperature, and (iii) the pressure. By contrast, the Power Density Factor (PF) and the Crossover (CO) are determined mainly by the engineering variables, being (iv) the inter-electrode distance, and (v) the current density.

In fact, the Power Density Factor (PF) is influenced in a minor way by one component of the Electrolyte Factor (EF), namely the Electrolyte Conduction Factor (CF), whereas the Crossover (CO) is influenced in a minor way by the other component of the Electrolyte factor (EF), namely the Gas Diffusion and Dissolution Factor (GDDF).

Thus, generally one is limited by nature and the laws of physics in where the Electrolyte Factor (EF) will peak. However, the Power Density Factor (PF) and the Crossover (CO) can be, effectively, determined or set for optimisation. In other words, one can find out where the Electrolyte Factor (EF) will peak, and then use the available control or freedom of the engineering quantities to cause the Power Density Factor (PF) and the Crossover (CO) to be simultaneously at minima (zeroed in the case of CO), or simultaneously as close to minima as possible.

In particular example embodiments, the inventors have therefore discovered that energy savings can be realised in a liquid-gas electrochemical cell having a liquid- or gel-electrolyte between the gas-producing electrodes by:
(1) providing a large, pre-formed or pre-existing bubble or bubbles (i.e. void volume(s), or gas region, or gas pathway, or bubble region), either natural or man-made, within, at, adjacent to or near to the source of gas in the cell in order to:
   i. reduce or minimise gas dissolution in the liquid electrolyte, and
   ii. reduce or minimise independent bubble formation;
(2) locating the pre-formed or pre-existing gas bubble(s) or region(s), either natural or man-made, outside of or on the periphery of the conduction pathway of the electrochemical cell, or to occupy only a small cross-sectional area within the conduction pathway of the electrochemical cell, so that its presence does not substantially increase the electrical resistance of the cell;
   and/or under circumstances where:
(3) the physical conditions within the cell and the cell design are set so that:
   i. the Electrolyte Factor (EF; for example in units of: L s/Ω cm³ mol) is increased or maximised to the greatest reasonable extent; and
   ii. the Power Density Factor (PF; for example in units of: mA² Ω/cm²) and the Crossover (CO; for example %), are reduced or minimized to the greatest reasonable extent.

In particular example embodiments, the inventors have further realised that not only can the energy efficiencies realised by this approach be more substantial than those achievable using other approaches, such as the use of solid-state ion-exchange membranes between the electrodes, but the energy efficiencies can also be most amplified under circumstances where energy losses are normally at their greatest in conventional cells; that is, at higher pressures and/or current densities.

In one example aspect, there is provided a liquid-gas electrochemical cell having a liquid- or gel-electrolyte between the gas-producing electrodes where:
(I) one or more void volumes, that lie outside of or on the periphery of the conduction pathway or occupy only a small cross-sectional area within the conduction pathway of the electrochemical cell, are located within, partially within, adjacent to, or near to the electrolyte; and where,
(II) the physical conditions in the cell and the cell design are set so that:
   i. the Electrolyte Factor (EF; for example in units of: L·s/Ω·cm³·mol) is increased or maximised to the greatest reasonable extent; and
   ii. the Power Density Factor (PF; for example in units of: mA²·Ω/cm²) and the Crossover (CO; for example in %), are reduced or minimized to the greatest reasonable extent.

Preferably but not exclusively, the one or more void volumes are directly adjacent to, next to, or positioned within the source of gas formation, in order to facilitate the migration of gas to the one or more void volumes. One or more “void volumes” can be provided by one or more porous structures, which can be gas permeable materials. The one or more porous structures, or gas permeable materials, providing one or more void volumes, are preferably gas permeable and liquid impermeable, or substantially liquid impermeable.

Preferably but not exclusively, the one or more void volumes are provided by a gas permeable material (i.e. a porous structure) that is not permeable to the electrolyte (i.e. liquid impermeable) but accommodates or allows passage of gas (i.e. gas permeable). Thus, in one preferred form, a void volume is provided by a gas permeable and liquid impermeable porous structure(s) or material(s). The one or more void volumes are preferably non-conductive.

In the case of an aqueous liquid electrolyte, the one or more void volumes are preferably but not exclusively provided by a porous hydrophobic structure, such as a porous hydrophobic assembly, membrane or hollow fibre, or a collection of such structures, which remains unfilled with liquid electrolyte or gel electrolyte during the operation of the cell.

The void volume, or the one or more void volumes, may be considered to be a “pre-existing bubble”, a “pre-formed bubble”, a “gas region”, a “gas pathway”, a “gas void”, an “artificial bubble” or a “man-made bubble”. Preferably the void volume, or the one or more void volumes, lies outside of or on the periphery of the electrical conduction pathway of the cell, or occupies only a small cross-sectional area within the electrical conduction pathway. In another example, the cross-sectional area of the void volume is less than the cross-sectional area of the electrical conduction pathway, relative to a perpendicular direction extending from the surface of an electrode.

Thus the one or more void volumes, e.g. a pre-existing bubble, gas region or gas pathway, either naturally occurring or man-made, in different examples, can be positioned:
(i) outside of the electrical conduction pathway between electrodes,
(ii) substantially outside of the electrical conduction pathway between electrodes,
(iii) partially outside of the electrical conduction pathway between electrodes,
(iv) peripheral to or adjacent to the electrical conduction pathway between electrodes,
(v) between the electrodes and within the electrical conduction pathway, but having a small cross-sectional area relative to the electrical conduction pathway between electrodes,
(vi) between the electrodes and parallel to the electrical conduction pathway, so as to have a small cross-sectional area relative to the electrical conduction pathway between electrodes,
(vii) between the electrodes and perpendicular to one or both of the electrodes, so as to have a small cross-sectional area relative to the electrical conduction pathway between electrodes, and/or
(viii) within, partially within, adjacent to or next to a liquid electrolyte or gel electrolyte of the cell.

Preferably but not exclusively, the cell can be operated under conditions where the Crossover (CO; in %), is reduced or minimized to the greatest reasonable extent. The Crossover (CO; in %) is the percentage of gases that cross from one electrode to the other due to gas migration in the liquid electrolyte. In example embodiments, the Crossover (CO) is preferably less than or equal to 40%. In example embodiments, the Crossover (CO) is less than or equal to 33%. In example embodiments, the Crossover (CO) is less than or equal to 30%, less than or equal to 20%, less than or equal to 15%, less than or equal to 12%, less than or equal to 10%, less than or equal to 8%, less than or equal to 5%, less than or equal to 4%, less than or equal to 3%, less than or equal to 2%, less than or equal to 1%, or less than or equal to 0.5%. In each case, the Crossover (CO) is greater than or equal to 0%. In another example, the Crossover (CO) is equal to or about 0%.

### High Pressure Operation

In particular example embodiments, the inventors have discovered that the operation of an electrochemical cell, under the conditions described herein, allows for cells that are capable of operating at higher pressures than are viable in many conventional electrochemical cells/systems. Additionally, the higher pressures are accompanied by greater energy efficiency and/or higher current densities. That is, in particular example embodiments, the inventors have discovered that the advantages of modes of operating the example electrochemical cells described herein, relative to comparable, conventional electrochemical cells, are so strongly and unexpectedly amplified as to allow for economically viable operation under hitherto unavailable or unviable conditions of increased pressure.

In particular example embodiments, the inventors have unexpectedly and remarkably discovered that the problems of gas crossover by bubbles through a separator, and gas pressure equalisation across the separator in an alkaline electrolyzer under high pressure conditions, can be ameliorated, eliminated or drastically curtailed by using appropriate gas diffusion electrodes at the anode and cathode and removing the separator entirely. Provided that the electrodes, preferably gas diffusion electrodes, have a suitably high wetting pressure and the pressure differential of the liquid over the gas side of the gas diffusion electrodes is not allowed to exceed that wetting pressure, then in particular example embodiments, the inventors have realised that it is possible to find physical conditions under which gas crossover is minimal and certainly far less than in a conventional electrochemical cell. As a result, it becomes possible to produce gases of high purity at high pressures. Additionally, progressive increases in the current density at high pressure have the effect of improving and not degrading the gas purity as is the case for conventional electrochemical cells.

That is, increases in the applied pressure in electrochemical cells of the present example embodiments should not degrade the purity of the one or more gases collected at the anode and/or cathode, at least not to near the extent observed in conventional cells. Moreover, when operated in this way, such cells are substantially more electrically and energy efficiently than comparable conventional cells. Increases in current density at pressure can also have the effect of progressively improving, and not degrading, the gas purity as is the case for conventional cells.

This can be accompanied by high energy efficiency and/or high current densities. This realisation has important practical utility since it can yield new industrial electro-synthetic and electro-energy processes that operate under hitherto unavailable or unviable conditions of pressure and/or current density.

For example, the inventors have remarkably discovered that the problem of (i) gas crossover through the separator and the problem of (ii) gas pressure equalisation across the separator in an alkaline electrolyzer under high pressure conditions, as described in WO2013/066331 and on pages 160-161 in the book “Hydrogen Production by Electrolysis”, by A. Godula-Jopek (Wiley-VCH, 2015), can be eliminated or drastically curtailed by using appropriate gas diffusion electrodes at the anode and cathode and then removing the separator entirely.

Removing the diaphragm, separator or ion exchange membrane also avoids the difficulties involved in equalising the pressure of the catholyte and anolyte chambers as observed in, for example, the electrolyzer developed by Avalence LLC described in WO2013/066331 and on pages 160-161 in the book “Hydrogen Production by Electrolysis”, by A. Godula-Jopek (Wiley-VCH, 2015). When the separator is removed, the catholyte and anolyte chambers become one, so that no pressure differential can then exist between the cathode and anode, at least from the pressure applied to the electrolyte. In concert with avoiding bubble formation, removal of the separator further eliminates crossover deriving from gas bubbles occupying the pores of the separator as observed in, for example, the aforementioned electrolyzer developed by Avalence LLC as described in WO2013/066331 and on pages 160-161 in the book “Hydrogen Production by Electrolysis”, by A. Godula-Jopek (Wiley-VCH, 2015).

The absence or substantial absence of bubbles in the liquid electrolyte further means that increasing current densities do not create an increasing electrical resistance and diminished energy efficiency arising from the “bubble overpotential”, “bubble-curtain” and “voidage” effects. For this reason, there is also a reduced requirement to rapidly pump electrolyte around the cell. Instead, higher current densities (at high pressure) have a beneficial effect, which involves mitigating and diminishing the relative amount of the gas crossover that occurs due to the migration of dissolved gases in the liquid electrolyte between the electrodes. The rate of such migration may be much smaller than that of bubble migration through a separator. It is also fixed by the physical conditions employed, including temperature, the concentration of salts in the liquid electrolyte, the extent of separation of the electrodes, the pressure applied on the liquid electrolyte and so forth. Since its rate is fixed, increasing the rate of overall gas generation by increasing the current density (under conditions of high pressure), acts to decrease the relative contribution of such gas crossover to the overall rate of gas production. In so doing, the impurities in the product gases created by gas crossover of this type become smaller, including vanishingly small, as the overall current density increases. That is, increases in current density (under conditions of high pressure) increase the purity of the gases generated and this occurs with high overall electrical efficiency.

These properties stand in stark contrast to the statement in the presentation for project PD117 in the 2015 Annual Merit Review Proceedings (Hydrogen Production and Delivery) of the US Department of Energy, to the effect that it is at present “Not possible to have high efficiency at high pressures”. Moreover, these unexpected properties overcome the fundamental impediments in high pressure alkaline electrolyzers, as illustrated in the electrolyzer developed by Avalence LLC described in WO2013/066331 and on pages 160-161 in the book “Hydrogen Production by Electrolysis”, by A. Godula-Jopek (Wiley-VCH, 2015), operation of which is limited both in the current density that can be efficiently applied and the fact that increases in pressure lead to increasingly impure gases (thereby, ultimately, limiting the maximum applied pressure).

As a result of these properties, the example electrochemical cells as described herein and in the Applicant's concurrent International Patent Applications entitled “Electrochemical cell and components thereof capable of operating at high current density” and “Electrochemical cell and components thereof capable of operating at high voltage”, filed on 14 Dec. 2016, which are incorporated herein by reference, can, unexpectedly, be used to generate high pressure gases of high purity at, optionally, a high current density and with, optionally, high electrical and energy efficiency without the need for a gas compressor. Similar principles apply to the reverse situation, namely fuel cells of the abovementioned type may utilize high pressure gases of high purity, at a high current density, to achieve high electrical and energy efficiency.

Accordingly, in one aspect, present embodiments provide for an electrochemical cell that generates one or more high purity gases at high pressure from a liquid electrolyte, without a gas compressor. Preferably, the cell operates with high electrical and energy efficiency.

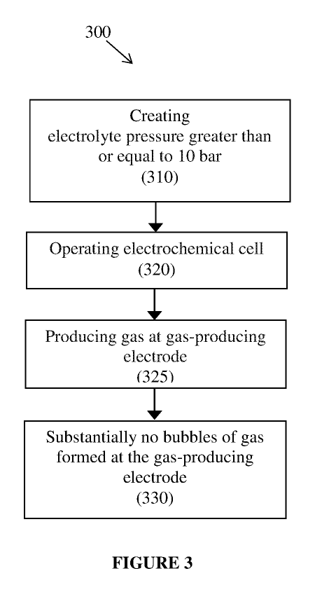

Referring to FIG. 3, there is shown a method 300 for producing a gas, or one or more gases, in an electrochemical cell, wherein the electrochemical cell includes a gas-producing electrode and a counter electrode (which in some examples may be a gas-producing counter electrode). The gas-producing electrode and the counter electrode are separated by an electrolyte, preferably the electrolyte is a liquid electrolyte or a gel electrolyte. The method comprises, at step 310, creating, selecting or setting an electrolyte pressure greater than or equal to 10 bar, and at step 320, operating the electrochemical cell at the created, selected or set electrolyte pressure. During operation (i.e. use) of the electrochemical cell, the gas is produced at the gas-producing electrode, at step 325, however substantially no bubbles of the gas are formed at the gas-producing electrode (or bubbles of the gas are not formed at the gas-producing electrode, or the gas-producing electrode is substantially free of bubble formation) (shown as step 330). It should be realised that the electrolyte pressure need not remain a constant value during operation of the electrochemical cell. In some examples, the electrolyte pressure can vary or be changed over different values, that are greater than or equal to 10 bar, during operation of the electrochemical cell.

Preferably, bubbles of the gas are not, or are substantially not, produced or formed at the gas-producing electrode. An electrical current, having a current density, is applied to the electrodes or a voltage can be applied across electrodes using an electrical power source. No bubbles, or substantially no bubbles, of the gas are formed or produced at the gas-producing electrode and/or the counter electrode, e.g. at the surfaces of the electrodes. That is, the electrochemical cell is substantially free of bubble formation, i.e. substantially bubble-free, at the gas-producing electrode and/or the counter electrode. This means that less than 15% of the gas formed or produced at the gas-producing electrode and/or the counter electrode takes the form of bubbles in the electrolyte. In a particular example, the gas-producing electrode and/or the counter electrode can include a porous conductive material, which can be flexible. Preferably, the porous conductive material is gas permeable and liquid permeable (i.e. electrolyte permeable). The gas-producing electrode and/or the counter electrode can include, or be next to, fixed to, or adjacent, a gas permeable material, which also can be flexible. Preferably, the gas permeable material is gas permeable and liquid impermeable (i.e. electrolyte impermeable), and thus the gas-producing electrode and/or the counter electrode composite structure can be gas permeable and liquid impermeable (i.e. electrolyte impermeable), and optionally flexible. Preferably, the gas permeable material is non-conductive. In other example embodiments, less than 10%) of the gas produced takes the form of bubbles in the electrolyte. In other example embodiments, less than 8%, less than 5%, less than 3%, less than 2%, less than 1%, less than 0.5%, or less than 0.25%, of the gas produced takes the form of bubbles in the electrolyte.

Also preferably, there is no diaphragm, separator or ion exchange membrane positioned between the gas-producing electrode and the counter electrode, i.e. between the anode and the cathode. In another example, the method includes selecting an Inter-electrode Distance (ID) between the electrodes and/or selecting a Current Density (CD) so that a Crossover (CO) for the electrochemical cell is less than or equal to 40%. Optionally, the Crossover (CO) is equal to or about 0%. In one example, one or more void volumes are located at or adjacent to the gas-producing electrode. An example method comprises operating the electrochemical cell at a current density greater than or equal to 50 mA/cm² and at an electrolyte pressure greater than or equal to 10 bar.

In example embodiments, high purity of a gas is preferably greater than or equal to 90%. In alternative example embodiments, high purity of a gas is preferably greater than or equal to 95%, greater than or equal to 97%, greater than or equal to 99%, greater than or equal to 99.5%, greater than or equal to 99.9%, greater than or equal to 99.99%, greater than or equal to 99.999%, greater than or equal to 99.9999%, or greater than or equal to 99.99999%. In another example, a produced gas has a purity equal to or about 100%.

It should be noted that “pressure” as used herein (including reference to “high pressure”), unless otherwise stated, refers to the “gas pressure” (e.g. a gaseous product(s) pressure), which is necessarily similar or close to, but somewhat below the “electrolyte pressure” (e.g. a liquid electrolyte pressure). The “electrolyte pressure” should not be more than the “gas pressure” plus the “wetting pressure of a membrane” (otherwise the membrane will leak/flood). In general, by way of example, the “gas pressure” is typically set to about 0.5 bar to about 1.5 bar below the “electrolyte pressure”.

In example embodiments, the electrolyte pressure is preferably greater than or equal to 10 bar. In alternative example embodiments, the electrolyte pressure is preferably greater than or equal to 20 bar, greater than or equal to 30 bar, greater than or equal to 40 bar, greater than or equal to 50 bar, greater than or equal to 60 bar, greater than or equal to 70 bar, greater than or equal to 80 bar, greater than or equal to 90 bar, greater than or equal to 100 bar, greater than or equal to 200 bar, greater than or equal to 300 bar, greater than or equal to 400 bar, or greater than or equal to 500 bar.

In another example aspect, the method includes selecting a current density at least partially based on an inter-electrode distance between the electrodes, to produce a crossover for the electrochemical cell. In one example, the current density is greater than or equal to 3 mA/cm², the inter-electrode distance is greater than or equal to 1 mm, and the crossover is less than or equal to 40%, 35%, 33%, 30%, 25%, 20%, 15%, 10%, 5% or 1%. In various other examples, the inter-electrode distance is greater than or equal to 3 mm, greater than or equal to 5 mm, greater than or equal to 10 mm, or greater than or equal to 25 mm.

In another aspect, the electrochemical cell generates high purity gases at high pressure from a liquid electrolyte at high current density and without a gas compressor.

In other examples, the high current density is: greater than or equal to 1 mA/cm², greater than or equal to 2 mA/cm², greater than or equal to 3 mA/cm², greater than or equal to 4 mA/cm², greater than or equal to 5 mA/cm², greater than or equal to 10 mA/cm², greater than or equal to 20 mA/cm², greater than or equal to 30 mA/cm², greater than or equal to 40 mA/cm², greater than or equal to 50 mA/cm², greater than or equal to 100 mA/cm², greater than or equal to 125 mA/cm², greater than or equal to 150 mA/cm², greater than or equal to 200 mA/cm², greater than or equal to 300 mA/cm², greater than or equal to 400 mA/cm², greater than or equal to 500 mA/cm², greater than or equal to 1000 mA/cm², greater than or equal to 2000 mA/cm², or greater than or equal to 3000 mA/cm².

In another example, the electrochemical cell generates high purity gases at high pressure from a liquid electrolyte without a gas compressor, where increases in the current density produce increases in the purity of the gases produced.

In another example, the electrochemical cell generates high purity gases at high pressure, with high current density and high energy efficiency from a liquid electrolyte without a gas compressor, where increases in the current density produce increases in the purity of the gases produced.

In another example, the electrochemical cell generates high purity gases at high pressure from a liquid electrolyte without a gas compressor, where the electrochemical cell combines at least one or both of a gas diffusion anode and a gas diffusion cathode.

In another example, the electrochemical cell generates high purity gases at high pressure from a liquid electrolyte without a gas compressor, where the electrochemical cell combines at least one or both of a gas diffusion anode and a gas diffusion cathode, both of which have relatively high wetting pressures.

In example embodiments, high wetting pressure is preferably greater than or equal to 0.2 bar. In alternative example embodiments, high wetting pressure is preferably greater than or equal to 0.4 bar, greater than or equal to 0.6 bar, greater than or equal to 0.8 bar, greater than or equal to 1 bar, greater than or equal to 1.5 bar, greater than or equal to 2 bar, greater than or equal to 2.5 bar, greater than or equal to 3 bar, greater than or equal to 4 bar, or greater than or equal to 5 bar.

In another example, the electrochemical cell generates high purity gases at high pressure from a liquid electrolyte without a gas compressor, where the electrochemical cell combines at least one or both of a gas diffusion anode and a gas diffusion cathode, both of which have relatively high wetting pressures, without a separator, ion exchange membrane or diaphragm between the anode and cathode.

In another example, the electrochemical cell generates high purity gases at high pressure from a liquid electrolyte without a gas compressor, where the electrochemical cell combines at least one or both of a gas diffusion anode and a gas diffusion cathode, each having relatively high wetting pressures, and where the pressure differential of the liquid over the gas side of the gas diffusion electrodes does not exceed the wetting pressures.

In another example, the electrochemical cell generates high purity gases at high pressure from a liquid electrolyte without a gas compressor, where the electrochemical cell combines at least one or both of a gas diffusion anode and a gas diffusion cathode, each having relatively high wetting pressures, where the pressure differential of the liquid over the gas side of the gas diffusion electrodes does not exceed the wetting pressures, and where the cell operates under physical conditions to minimise the migration of gases dissolved in the liquid electrolyte between the electrodes.

In another example, the electrochemical cell generates high purity gases at high pressure from a liquid electrolyte without a gas compressor, where the electrochemical cell combines at least one or both of a gas diffusion anode and a gas diffusion cathode, each having relatively high wetting pressures, where the pressure differential of the liquid over the gas side of the gas diffusion electrodes does not exceed the wetting pressures, and where the cell operates at high electrical and energy efficiency.

In another example, the electrochemical cell generates high purity gases at high pressure from a liquid electrolyte without a gas compressor, where the electrochemical cell combines at least one or both of a gas diffusion anode and a gas diffusion cathode, each having relatively high wetting pressures, where the pressure differential of the liquid over the gas side of the gas diffusion electrodes does not exceed the wetting pressures, and where the cell operates at high current density.

In another example, the electrochemical cell generates high purity gases at high pressure from a liquid electrolyte without a gas compressor, where the electrochemical cell combines at least one or both of a gas diffusion anode and a gas diffusion cathode, each having relatively high wetting pressures, where the pressure differential of the liquid over the gas side of the gas diffusion electrodes does not exceed the wetting pressures, and where the cell operates under conditions where the cell is able to handle rapid increases in current density, including under conditions of highly intermittent current supply, such as may be afforded by a renewable energy source, like wind generators or solar panels or an ocean wave/tidal-generators.

In example embodiments, only a lessened or minor requirement to pump electrolyte around the cell is necessary, the electrolyte replacement rate is preferably less than 1 replacement of the electrolyte in the cell volume every 1 hour. In alternative example embodiments, the electrolyte replacement rate is preferably less than 1 replacement of the electrolyte in the cell volume every 45 minutes, less than 1 replacement of the electrolyte in the cell volume every 30 minutes, less than 1 replacement of the electrolyte in the cell volume every 15 minutes, less than 1 replacement of the electrolyte in the cell volume every 10 minutes, less than 1 replacement of the electrolyte in the cell volume every 5 minutes, less than 1 replacement of the electrolyte in the cell volume every 1 minute, less than 1 replacement of the electrolyte in the cell volume every 30 seconds, less than 1 replacement of the electrolyte in the cell volume every 5 seconds, or less than 1 replacement of the electrolyte in the cell volume every 1 second.

In a further example aspect, there is provided electro-synthetic or electro-energy cells, such as an electrochemical cell or a fuel cell, with one or more gas diffusion electrodes that are bubble-free or substantially bubble-free in operation, wherein the cell is operated at high pressure and/or high current density.

In another example aspect, there is provided an electro-synthetic or electro-energy cell, comprising a liquid electrolyte and at least one gas diffusion electrode; the at least one gas diffusion electrode being bubble-free or substantially bubble-free in operation, wherein in use the cell is operated at high pressure and/or high current density.

Similar principles apply to the reverse situation, namely: cells of the abovementioned type can utilize high purity gases at high pressure (obtained with or without use of a compressor), at, optionally, a high current density, to thereby, optionally, achieve high electrical and energy efficiency.

These examples provide for:
(1) An electrochemical cell that does not contain an ion-permeable diaphragm between the anode and the cathode of the cell, and that generates high purity gases, or one or more pure gases, at high pressure from a liquid or gel electrolyte, without need for a gas compressor.
(2) An electrochemical cell that does not contain an ion-permeable diaphragm between the anode and the cathode of the cell, and that operates in a bubble-free manner or substantially bubble-free manner, to generate high purity gases, or one or more pure gases, at high pressure from a liquid or gel electrolyte, without need for a gas compressor.
(3) An electrochemical cell that does not contain an ion-permeable diaphragm between the anode and the cathode of the cell, and that operates in a bubble-free or substantially bubble-free manner, to generate high purity gases, or one or more pure gases, at high pressure from a liquid or gel electrolyte, without need for a gas compressor, where the cell operates:
   i. with high current density and/or high energy efficiency; and/or
   ii. where increases in the current density yield increases in the purity of the gases produced.

### Operation Involving Sudden and Large, Intermittent and Fluctuating Currents

In example embodiments, methods for facilitating rapid increases in current density in cells, including under conditions of highly intermittent current supply, such as may be afforded by a renewable energy source, like wind generators, solar panels or ocean wave/tidal generators, are described in the Applicant's concurrent International Patent Application entitled “Electrochemical cell that operates efficiently with fluctuating currents”, filed on 14 Dec. 2016, which is incorporated herein by reference.

Many known gas generating liquid-filled electrochemical cells, like conventional alkaline electrolyzers, cannot handle sudden and large increases in current as may occur when they are directly connected to highly intermittent current supplies, such as may be afforded by renewable energy sources like wind generators, solar panels or ocean wave/tidal generators. In the case of a very rapid rise in current, a large amount of gas may be produced very quickly in such cells, creating a potential pressure burst hazard and also potentially forcing the liquid electrolyte out of the cell, thereby damaging the cell either mechanically, or electrochemically, or both.

Where porous electrodes have been used, it may also be imperative to avoid sudden, large-scale gas evolution in the pores since the formation of bubbles in this way can mechanically damage the catalyst, causing crumbling or erosion of the catalyst particles. There are various other ways in which a cell may be damaged by a sudden current surge.

Thus, numerous patents teach methods and procedures by which to instantly or progressively cut liquid-filled cells off from an electrical supply when its current surges too strongly. For example, US20140120388 teaches of a cut-off switch for a battery during recharging where the activation of the cut-off switch is linked to the pressure of any gas that may be produced. US20120181992 teaches of a cut-off switch that is linked to the voltage of a battery connected to an intermittent source of energy. US20110156633 teaches of a solar power system that modulates the voltage of the incoming, intermittent current, in order to avoid damage. Conventional alkaline electrolyzers must typically be operated at current densities of around 300 mA/cm² with surges in current limited to no more than ca. 20-30% of that value.

By contrast, in particular examples the inventors have discovered that the example electrochemical cells as described herein, which operate most economically at low current densities, are unexpectedly able to be operated under conditions of remarkably large and extremely sudden surges in current, with no noticeable degradation in subsequent performance.

Experiments have shown that the example electrochemical cells as described herein can be operated under unexpected conditions or ranges to routinely handle current surges of at least 25-fold over their normal operating currents, delivered within mere milliseconds. Moreover, testing has revealed that the electrochemical cells can handle surges of such scale repeatedly, without noticeable degradation in their electrochemical performance, at intervals of a few seconds, applied continuously and without break, over periods exceeding six months. To the best of the inventors' knowledge, no other cell types and most especially no other liquid-containing cells, are capable of such feats.

The origin of this truly remarkable capability appears to lie in features noted earlier. As mentioned above, it is energetically more favourable for newly formed or dissolved gas within a liquid to join a large, pre-existing bubble than it is for the gas to form a new bubble. Moreover, the concentration of dissolved gas within a liquid electrolyte is also minimised and held below super-saturation levels, about a pre-formed bubble since the bubble provides an additional interface through which excess gaseous molecules may quickly and easily escape the liquid phase. Thus, it is, effectively, impossible for a liquid electrolyte to become supersaturated near to an existing bubble, since the bubble interface provides a ready and favourable route for the excess gas to escape the liquid phase.

Accordingly, if an “artificial bubble”, such as the gas side or region of a gas diffusion electrode is present near to the point of formation of a gas in a liquid-containing cell, then the newly formed gas is strongly favoured to join that “artificial bubble” rather than to form a new bubble or dissolve in a supersaturated way within the liquid. Moreover, if that “artificial bubble” has a substantial volume and a large gas-liquid interface, then it can accommodate and absorb even very large quantities of a gas that may be formed extremely suddenly in the liquid phase. In other words, the “artificial bubble”, represented by the gas side of a gas diffusion electrode, may act as a buffer that rapidly assimilates and removes even substantial quantities of gas formed very quickly within the liquid phase. In this way, the damage that may be caused by sudden, large-scale bubble formation may be eliminated in its entirety, or, at least, mitigated to a substantial extent.

Furthermore, because the “artificial bubble”, represented by the gas side of a gas diffusion electrode, lies outside of the electrical conduction pathway through the liquid electrolyte, the sudden formation of large quantities of gas need not affect in any substantial way, the electrical resistance of the liquid electrolyte. That is, not only is the potentially damaging effect of sudden bubble formation mitigated, but the electrical resistance and hence the electrical and energy efficiency of the cell, may also be substantially unaffected. In other words, the cell remains capable of operating with amplified energy efficiency relative to conventional cells, during sudden and large-scale surges in current.

These realisations provide for:
(1) A liquid- or gel-containing electrochemical cell that is capable of accommodating large and sudden increases and/or fluctuations in an applied current without experiencing substantive damage, the cell including:
   i. one or more void volumes positioned or located outside of, or substantially outside of, or partially outside of, or on the periphery of, or within but only providing a small cross-section of, the electrical conduction pathway through the liquid or gel electrolyte; and.
   ii. current collectors and/or electrodes;
where
   iii. the one or more void volumes are capable of accommodating the gases generated during large and sudden increases and/or fluctuations in an applied current; and
   iv. the current collectors and/or electrodes in the cell are capable of accommodating large and sudden increases and/or fluctuations in an applied current.
(2) A method for fabricating a liquid- or gel-containing cell that is capable of accommodating large and sudden increases and/or fluctuations in an applied current without experiencing substantive damage, the method involving
   i. positioning or locating one or more void volumes within, adjacent to or near to the liquid or gel electrolyte, but outside of, or substantially outside of, or partially outside of, or on the periphery of, or within but only providing a small cross-section of, the electrical conduction pathway through the liquid or gel electrolyte; and
   ii. locating current collectors and/or electrodes within the cell;
where
   iii. the one or more void volumes are capable of accommodating the gases generated during such surges; and
   iv. the current collectors and/or electrodes in the cell are capable of accommodating the currents involved in such surges.
      High Electrical and/or Energy Efficiency Operation

In example embodiments, methods for operating electrochemical cells at high electrical and energy efficiencies, are described in the Applicant's concurrent International Patent Application entitled “Method and system for efficiently operating electrochemical cells”, filed on 14 Dec. 2016, which is incorporated herein by reference.

Example methods for operating cells at high electrical and energy efficiencies may occur when an endothermic electrochemical reaction is facilitated. In such applications, the cells can act to minimise or, at least, noticeably decrease the intrinsic energy inefficiencies involved in electrochemical cells that facilitate liquid-gas reactions. For example, the energy sapping influence that bubbles may have in such cases, may be substantially mitigated.

In particular example embodiments, the inventors have further recognised that, for such endothermic electrochemical reactions, there may be at least one catalyst available that is capable of sustainably catalyzing the reaction at cell voltages below or near to the so-called “thermoneutral voltage”, which represents the maximum possible energy efficiency with which the cell can operate. In order to properly realise the potential energy efficiencies, it may be necessary to employ cells of the present embodiments, which provide a minimisation or, at least, a noticeable reduction in the intrinsic inefficiencies that may otherwise have been present.

In example embodiments, the electrical efficiency is defined as the ratio of the total energy put into the cell relative to the total energy incorporated in the products generated by the cell over a particular time period. In example embodiments, high electrical and energy efficiency is preferably greater than or equal to 70%. In alternative example embodiments, high electrical and energy efficiency is preferably greater than or equal to 75%, greater than or equal to 80%, greater than or equal to 85%, greater than or equal to 87%, greater than or equal to 90%, greater than or equal to 93%, greater than or equal to 95%, greater than or equal to 97%, greater than or equal to 99%, or greater than or equal to 99.9%.

New methods of operation of the example electrochemical cells at or near ambient (eg. room) temperature as described herein, are predicated on the fact that the cells may be operated economically-viably at low current densities. They may also be utilized to facilitate reactions which are endothermic in nature; that is, reactions which absorb heat. This is significant since, for reactions of that type, there may be catalysts available that catalyze the reaction at cell voltages below the so-called “thermoneutral” voltage at or near ambient (eg. room) temperature but they can only do so at low current densities.

Thus, the inventors have understood that operating a suitable catalyst at operational voltages below, at, about or near to the thermoneutral voltage, at or near to ambient temperatures, where they produce only low current densities, within cells that operate viably at low current densities, offers a useful approach to the development of energy efficient liquid-gas electrochemical cells.

The inventors have further realised that at a fixed current density, the operational voltage of such a cell may decline with an increase in temperature. That is, higher current densities at, about or near to the thermoneutral voltage may be achieved for a suitable catalyst by increasing the temperature of the cell. Provided the cell is capable of withstanding the higher temperatures without damage or impairment, it is possible to operate cells at, about, or near to the thermoneutral voltage with higher current densities at higher temperatures.

Thus, the inventors have understood that operating a suitable catalyst at operational voltages below, at, about or near to the thermoneutral voltage at higher temperatures, where they produce higher current densities, within cells that capable of withstanding the higher temperatures without damage or impairment, offers a useful approach to the development of energy efficient liquid-gas electrochemical cells.

The inventors have, additionally, understood that another useful approach to thermal management in such cells, known as “thermal self-regulation”, involves allowing the operational temperature of the cell to vary in accordance with the thermal parameters and not be fixed. That is, a useful approach to thermal management involves allowing the cell to find its own optimum operating temperature in a process of “thermal self-regulation”. Optionally, this may be done with the cell wrapped in thermal insulation. This approach involves applying a particular current density as required (in the presence of suitable catalysts). If, at the temperature of the cell, the applied current density creates a higher voltage in the cell than the thermoneutral voltage, then the cell will progressively heat itself up. As the cell heats itself up, the cell voltage will typically decline. At the applied, fixed, current density, the cell will continue heating itself up until such time as the cell voltage has declined to be at, about, or near to the thermoneutral voltage (depending on the quality of the thermal insulation). At that point, the temperature of the cell will stabilize and cease increasing. During the entire process the cell would be operating at as close to 100% energy efficiency as the thermal insulation will allow. The reverse of the above will occur (causing a decrease in the operating temperature of the cell) if the current density that is applied causes the cell voltage to decline.

The thermoneutral voltage is defined as that cell voltage at which the heat generated by the catalyst and associated conductors is equal to the heat consumed by the reaction. If an endothermic electrochemical reaction is carried out at the thermoneutral voltage, then the energy and electrical efficiency of the conversion of reactants into products is, by definition, 100%, since all of the energy that is put into the cell is necessarily converted into energy within the products of the reaction. That is, the total electrical and heat energy put into the cell is matched with the total energy present in the products of the reaction with no excess input energy radiated to the surroundings. However, if the reaction is carried out above the thermoneutral voltage, then excess energy is generated, usually in the form of heat. If the reaction is carried out below the thermoneutral voltage, then energy, usually in the form of heat, needs to be added in order to avoid self-cooling by the system.

In particular example embodiments, the inventors' have realised that example electrochemical cells as described herein can be operated at, below, or near to the thermoneutral potential in an economically-viable way, for example so as to avoid the need for extensive and energy-sapping electrical cooling systems. This realisation has important and far-reaching implications for the heat management and energy efficiency of such cells. With sufficiently powerful catalysts and/or suitably high temperatures, example electrochemical cells of the type described in the Applicant's concurrent International Patent Applications entitled “Electrochemical cell and components thereof capable of operating at high current density” and “Electrochemical cell and components thereof capable of operating at high voltage”, filed on 14 Dec. 2016, which are incorporated herein by reference, can be operated at, below, or near to the thermoneutral potential in an economically-viable way.

In particular example embodiments, the inventors have produced suitable example catalysts, which facilitate electrocatalytic water electrolysis. The catalyst(s) is applied to at least one of, or both of, the electrodes to facilitate the endothermic electrochemical reaction at the operational voltage of the electrochemical cell. In preferred but non-limiting examples, the catalyst contains one or more of the following catalytic materials: (i) Precious metals, either free or supported, including but not limited to Pt black, Pt supported on carbon materials (eg Pt on carbon black), Pt/Pd on carbon materials (eg Pt/Pd on carbon black), IrO₂, and RuO₂; (ii) Nickel, including but not limited to: (a) nanoparticulate nickels, (b) sponge nickels (eg. Raney nickel), and (c) nickel foams; (iii) Nickel alloys, including but not limited to, NiMo, NiFe, NiAl, NiCo, NiCoMo; (iv) Nickel oxides, oxyhydroxides, hydroxides, and combinations thereof, without limitation; (v) Spinels, including but not limited to NiCo₂O₄, Co₃O₄, and LiCo₂O₄; (vi) Perovskites, including but not limited to La_{0.8}Sr_{0.2}MnO₃, La_{0.6}Sr_{0.4}Co_{0.2}Fe_{0.8}O₃, and Ba_{0.5}Sr_{0.5}Co_{0.2}Fe_{0.8}O₃; (vii) Iron, as well as iron compounds, including but not limited to nanoparticulate iron powders and the like; (viii) Molybdenum compounds, including but not limited to MoS₂; (ix) Cobalt, as well as cobalt compounds, including but not limited to nanoparticulate cobalt powders and the like; and (x) Manganese, as well as manganese compounds, including but not limited to nanoparticulate manganese powders and the like.

In another example, the catalyst's comprises one or more of the above catalytic materials mixed in with PTFE (eg. in a 5% dispersion in alcohol from Sigma-Aldrich), creating a slurry. The slurry is preferably, but not exclusively, coated, for example knife-coated, onto the electrode(s) and conductor(s) in a layer or coating. In one particular example, after drying, the catalyst contains about 40% by weight PTFE, about 60% by weight of the catalytic materials. Optionally, carbon black may also be added to the slurry.

The above percentages of component materials in the catalyst can be varied and the catalyst can remain functional. For example, suitable ranges for the catalyst, when dry, are:
about 5% to about 95% by weight of PTFE, and
about 5% to about 95% by weight of the catalytic materials.

In another example, suitable ranges for the catalyst, when dry, are:
about 5% to about 90% by weight of PTFE,
about 5% to about 90% by weight of uncoated carbon black, and
about 5% to about 90% by weight of the catalytic materials.

In another example, there is no ion exchange membrane positioned between the electrodes. In another example, there is no diaphragm positioned between the electrodes. In another example, the electrolyte is a liquid electrolyte or a gel electrolyte. In another example, bubbles of the produced gas, or at least one gas, are not, or are substantially not produced or formed at either of the electrodes.

Conventional cells that can only operate economically above the thermoneutral potential, will necessarily develop excess heat which has to be removed by a suitable cooling system during operation. Cooling systems, such as chillers, are typically expensive and energy inefficient. Thus, not only does such a conventional cell operate at a voltage that creates and wastes excess heat, but further energy must then be expended to remove that excess heat. The resulting multiplier effect will typically have the effect of dramatically diminishing the overall energy efficiency of the cell during routine operation. For example, small-scale water electrolyzers that generate 0.5-10 kg/day of hydrogen during routine operation, typically consume 75-90 kWh per kilogram of hydrogen produced. However, one kilogram of hydrogen, in fact, only requires 39 kWh of energy to manufacture. The difference is largely due to the waste heat that is generated and the need for an energy inefficient chiller to remove the waste heat.

By contrast, an electrochemical cell that operates at, below, or near to the thermoneutral potential does not create substantial excess heat that needs to be removed. If an electrochemical cell can be operated near the thermoneutral potential, then there may be so little excess heat generated that it is easily lost to the surroundings without any need for a formal or dedicated cooling system. Alternatively, the excess heat can be used to maintain a particular operating temperature that is higher than ambient temperature. If an electrochemical cell can be operated at the thermoneutral potential, then there is no heat exchanged with the surroundings at all. If an electrochemical cell can be operated below the thermoneutral potential, then heat must be applied to the cell/system in order to maintain the cell/system temperature and prevent it from cooling. However, in such an unexpected mode of operation, the inventors have realised that such required heat can be, relatively easily, efficiently and quickly, produced using electricity; for example, by resistive heating. Moreover, it becomes possible to apply only so much heat as is needed to maintain the cell temperature, thereby ensuring that the cell wastes no energy and operates at as close to 100% efficiency as is possible.

By these means, heat management of an endothermic reaction in an electrochemical cell can become a drastically simpler and more efficient matter than is possible at present. In effect, the common and usually problematic phenomenon of heating in electrochemical cells can be turned into an advantage in cells that operate in an economically-viable way below the thermoneutral potential. That is, it may be utilized to ensure the cell is operating at the maximum possible efficiency. Such an option is not available to conventional cells that must operate at high current densities in order to be economically viable and/or that may be irretrievably damaged or impaired at high operating temperatures.

For example, water electrolysis is an endothermic process. Of the 39 kWh theoretically required to form 1 kg of hydrogen gas, 33 kWh must be supplied in the form of electrical energy and 6 kWh must be supplied in the form of heat energy. Several catalysts are known to be capable of catalysing water electrolysis at voltages less than the thermoneutral cell potential for water electrolysis, which is 1.482 V at room temperature.

However, all such catalysts only yield relatively low current densities at or below the thermoneutral potential at typical ambient temperatures. Accordingly, conventional water electrolyzers, which can only be operated in an economically-feasible way at high current densities cannot harness this effect with any sort of utility. They must necessarily operate at voltages well above the thermoneutral voltage, causing the formation of excess heat, which must then be removed at a further energy penalty.

Even in cases where the cell operates at somewhat above the thermoneutral voltage, the cell may be sufficiently close to the thermoneutral voltage that the excess heat generated, along with additionally applied electrical heat, is such as to warm the cell up to a more optimum operating temperature and maintain it there without need for a formal or dedicated cooling system.

These teachings have potentially important and far-reaching implications for the heat management, energy efficiency, and capital cost of electrochemical liquid-gas cells. These options have not hitherto been available in conventional cells which only operate viably at high current densities. In particular, the new approaches teach that excess heat is a valuable resource that needs to be shepherded and conserved, not wasted.

These realisations provide for:
(1) A heat management system for an electrochemical cell that facilitates an endothermic reaction, where:
   i. The cell employs catalysts that are capable of catalysing the reaction below or near its thermoneutral cell voltage at ambient temperature, and
   ii. The cell is maintained at or near a suitable temperature,
   iii. Where necessary, by the application of electrical heating, including, without limitation, electric resistive heater.
(2) Optionally, the cell may be thermally insulated from the cell's surroundings by encasing the cell, either partially or fully, in a thermally insulating material(s).

### High Current Density Operation

In example embodiments, methods for facilitating the operation of cells at high current densities, are described in the Applicant's concurrent International Patent Application entitled “Electrochemical cell and components thereof capable of operating at high current density”, filed on 14 Dec. 2016, which is incorporated herein by reference.

In example embodiments, high current density is preferably greater than or equal to 50 mA/cm². In other example embodiments, high current density is preferably greater than or equal to 100 mA/cm², greater than or equal to 125 mA/cm², greater than or equal to 150 mA/cm², greater than or equal to 200 mA/cm², greater than or equal to 300 mA/cm², greater than or equal to 400 mA/cm², greater than or equal to 500 mA/cm², greater than or equal to 1000 mA/cm², greater than or equal to 2000 mA/cm², or greater than or equal to 3000 mA/cm².

In such high current density operation, after cell adaption to this purpose, the aforementioned cells may operate at substantially higher energy and electrical efficiencies than are available for comparable, conventional cells. That is, the advantages of example electrochemical cells as described herein, suitably adapted, may be most strongly amplified at high current densities relative to a comparable conventional cell. This discovery has important practical utility since many industrial electro-synthetic and electro-energy cells aim to operate at the highest reasonable current densities. Substantial energy and electrical savings may therefore be realised.

Moreover, for electrochemical reactions where high current densities and high energy efficiencies are necessary in order to achieve economic viability, this discovery can yield new industrial electro-synthetic and electro-energy processes that were hitherto unavailable or unviable.

Adaption of the example electrochemical cells as described herein, including, but not limited to cells of the types described in WO2013/185170, WO2015/013765, WO2015/013766, WO2015/013767, and WO2015/085369, may involve special designs for or modifications to the current collectors, busbars, electrical connections, power supplies/receivers, and other components. For example, selected components within the power supply of an electrosynthetic cell of the aforementioned types may be specially designed in order to handle the high current densities. In example embodiments, power supplies for facilitating the operation of cells of the above types, are described in the Applicant's concurrent United States Provisional Application entitled “DC power supply systems and methods”, filed on 14 Dec. 2016, which is incorporated herein by reference. Similarly, novel current collectors such as asymmetric conducting meshes may be used, if required, in order to effectively distribute current at high current densities. One particular adaption involves the use of series electrical connections as described in the Applicant's concurrent International Patent Application entitled “Electrochemical cell and components thereof capable of operating at high voltage”, filed on 14 Dec. 2016, which is incorporated herein by reference.

In one example aspect, there is provided a spiral-wound electrochemical cell, module or reactor capable of operating at high current density, having a core element, around which one or more electrodes (e.g. at least one electrode pair provided by an anode or a cathode) may be wound in a spiral fashion. The at least one electrode pair can form part of a multi-electrode array, which can be considered as being comprised of a series of flat flexible anodes and cathodes that can optionally be wound in a spiral fashion. A “leaf” is comprised of one or more electrodes, for example an electrode, a pair of electrodes, a plurality of electrodes, or some other form of electrode unit. A leaf may be flexible and can be repeated as a unit. Thus, in one example the electrode(s) is flexible, for example at least when being wound. After being wound, in some examples, the electrode(s) might be hardened using a hardening process.

For example, a leaf can include in part, or be formed by:
two electrodes, for example two cathodes or two anodes;
an electrode pair, for example an anode and cathode; or
a plurality of any of the above.

In another example, a leaf can include in part, or be formed by, two electrode material layers (with both layers together for use as an anode or a cathode) that are positioned on opposite sides of an electrode gas channel spacer (i.e. a spacer material, layer or sheet, which for example can be made of a porous polymeric material) which provides a gas or fluid channel between the two electrodes.

Repeated leafs provide a multi-electrode array being a set of flat-sheet or spiral—wound electrodes with intervening, electrically-insulating “flow-channel” spacers between electrodes of different polarity (e.g. between an anode and a cathode) providing separated liquid channels. The electrochemical cell, module or reactor may optionally also involve end caps, and one or more external elements.

In example embodiments there is provided a core element and end caps for a spiral-wound electrochemical cell capable of facilitating high current densities, the core element, end caps, and/or external elements comprising or containing an electrically conductive element, such as a (primary) busbar, provided as the end cap; and wherein, the conductive element is able to receive a conductive end from, or part of a conductive end from, or an electrode from, or a (secondary) busbar from an electrode, which may be a flexible electrode, where the electrode may be in a flat-sheet arrangement or may be spiral-wound about the core element. In another embodiment, the conductive element is able to provide a conductive lip to, or part of a conductive lip to, or an electrode to, or a (secondary) busbar to an electrode, which may be a flexible electrode, where the electrode is optionally able to be spiral-wound about the core element.

In example embodiments, the current collectors of all anode electrodes are placed so as to overhang their electrodes on one side of the assembly of electrodes, leafs or the like, while the current collectors of all the cathode electrodes are placed so as to overhang their electrodes on the opposite side to the anode electrodes. All of the overhanging anode electrodes are then combined into a single electrical connection, while all of the overhanging cathode electrodes are separately combined into a single electrical connection. If multiple leafs are connected by the approach, this method may result in a parallel electrical connection of the leafs.

In these example aspects there are provided methods for forming the electrical connections with the flexible electrode leaf so as to thereby appropriately bring together, group, or aggregate electrodes in the leaf into single electrical fittings capable of facilitating high current densities, for example, in a parallel electrical connection. These are preferably, but not exclusively, achieved by one of the means described below.

For example, one method involves interdigitating metallic wedges between spiral current collectors extending off one end of the spiral-wound cell and then bringing the interdigitated wedges into electrical contact via a primary busbar with an attached connecting bus (‘Wedge method’). In an alternative example, the current collector, interdigitated wedges and ring may be bolted together, in which case the method is known as the “Bolted Wedge Method”: Alternatively, the current collectors, wedges and ring may be welded together, in which case the method is known as the “Welded Wedge” Method. The wedges may be narrowly disposed in finger-like projections off of the central ring, in which case the method is known as the “narrow wedge method”. Alternatively, the wedges may be widely disposed, in which case the method is known as the “wide wedge method”.

Variations to the “Wedge Method”:
i. In these methods the overhanging current collectors from either the anode or cathode electrodes, leafs, or the like, are brought down into a collection of conductive powder (“Powder Method”) or small/microscopic spheres (“Sphere Method”), and a ring. Thereafter, the powder or spheres are placed in secure mechanical and electrical contact with the current collectors and the ring. For example, the powder or spheres may be welded to the current collectors and the ring, thereby creating a primary busbar as an end cap of the cell.
ii. “Solder method”: In this method the overhanging current collectors from either the anode or cathode electrodes, leafs, or the like, are brought down into a powdered solder encircling a conductive ring. Thereafter, the solder is placed in secure mechanical and electrical contact with the current collectors and the ring by heating the assembly.
iii. “Continuous Wedge Method”: In this variant, a wire, for example a square, rectangular, triangular or flat wire, of suitable thickness is wound around the ring. The wire replaces the discrete wedges used in the “Wedge Method”. In effect, the wire forms a continuous wedge. The overhanging current collectors are brought down over the continuous wedge such that the current collectors interdigitate the continuous wedge, which fills the space between the current collectors. Thereafter, the wire is placed in secure mechanical and electrical contact with the current collectors and the ring by, for example, welding the assembly.
iv. “Spiral Method”: In this approach a primary busbar is manufactured by forming a spiral ledge into a circular conductor located at, or itself being, an end cap. The overhanging current collectors on the anode or cathode are formed to match the spiral ledge such that when the cell is spirally-wound, the overhanging current collectors fall on the ledge and can be securely and continuously welded to the ledge during the winding process.

These methods provide for:
(1) An electrochemical cell for an electrochemical reaction, comprising:
   a wound electrode; and,
   a busbar attached to a current collector of the electrode, where the current collector is spiral-wound, and
   wherein the busbar is of such size and such design as to provide for operation of the cell at high current density.
(2) A spiral-wound electrochemical cell for forming a chemical reaction product from an electrochemical reaction, the electrochemical cell comprising:
   an electrode spiral-wound about a central axis;
   an end cap; and,
   a busbar provided as part of the end cap;
   wherein the busbar is attached to a current collector of the electrode, and the current collector is spiral-wound, and
   wherein the busbar is of such size and such design as to provide for operation of the cell at high current density.

### High Voltage Operation

As described in the Applicant's concurrent International Patent Application entitled “Electrochemical cell and components thereof capable of operating at high voltage”, filed on 14 Dec. 2016 and incorporated herein by reference, example electrochemical cells are disclosed for operation at high voltages. One example adaption involves arraying example cells in electrical series.

In example embodiments, high voltage is preferably greater than or equal to 2 V. In other example embodiments, high voltage is preferably greater than or equal to 3 V, greater than or equal to 5 V, greater than or equal to 10 V, greater than or equal to 25 V, greater than or equal to 50 V, greater than or equal to 100 V, greater than or equal to 250 V, greater than or equal to 500 V, greater than or equal to 1000 V, or greater than or equal to 2000 V.

The series-connected cells are distinguished from spiral-wound and related, parallel-connected cells in that they allow for the use of substantially smaller and more readily connected primary busbars. Moreover, the cells allow for the use of a lower overall current but higher overall voltage than is generally utilized by related parallel-connected cells, including spiral-wound cells of the aforementioned type. This may be advantageous in that lower overall currents provide for lesser electrical resistance and therefore lesser (heat) losses, than higher overall currents. Moreover, power supplies which provide low overall current and high voltage are generally less expensive than power supplies which provide high overall current and low voltage. In example embodiments, power supplies for facilitating the operation of series-connected cells of these types, are described in the Applicant's concurrent United States Provisional Application entitled “DC power supply systems and methods”, filed on 14 Dec. 2016, which is incorporated herein by reference.

In other words, cells with series connections consume lower overall currents of higher overall voltage than cells with parallel connections that have the equivalent overall active electrochemical area and the same current density. In so doing, cells with series connections require smaller primary busbars than are necessary when large overall currents are required.

Other advantages of a series arrangement in a cell include:
(1) it is typically simpler and less complex to connected busbars to series-connected cells than to their equivalent parallel-connected counterparts,
(2) series-connected cells display an improved ability to handle large and sudden surges in current (since the system operates generally at lower overall currents), and
(3) series-connected cells better allow for the use of current collectors of higher intrinsic resistance, since the overall current affects the overall resistance, which is related to the efficiency of the cell. A lower current yields a lower overall resistance, even with current collectors having a higher intrinsic resistance, thereby avoiding substantial penalty to the efficiency of the cell.

The disadvantages of series-connected cells relative to parallel-connected cells include the presence of parasitic currents.

In an example embodiment there is provided a plurality of electrochemical cells for an electrochemical reaction. The plurality of electrochemical cells comprises a first electrochemical cell including a first cathode and a first anode, wherein at least one of the first cathode and the first anode is a gas diffusion electrode. The plurality of electrochemical cells also comprises a second electrochemical cell including a second cathode and a second anode, wherein at least one of the second cathode and the second anode is a gas diffusion electrode. Preferably, the first cathode is electrically connected in series to the second anode by an electron conduction pathway.

Preferably, chemical reduction occurs at the first cathode and the second cathode as part of the electrochemical reaction, and chemical oxidation occurs at the first anode and the second anode as part of the electrochemical reaction. In a particular example, the first cathode is a gas diffusion electrode. In another example, the first anode is a gas diffusion electrode. In another example, the second cathode is a gas diffusion electrode. In another example, the second anode is a gas diffusion electrode. In another example, an electrolyte is between the first cathode and the first anode. In another example, the electrolyte is also between the second cathode and the second anode.

Preferably, there is no diaphragm or ion exchange membrane positioned between the first cathode and the first anode. Also preferably, there is no diaphragm or ion exchange membrane positioned between the second cathode and the second anode. In another example, in operation there is no voltage difference between the first cathode and the second anode. In another example, in operation there is a voltage difference between the first cathode and the second cathode.

In example operation of the cell, a first gas is produced at the first cathode, and substantially no bubbles of the first gas are formed at the first cathode, or bubbles of the first gas are not formed at the first cathode. Also in example operation of the cell, a second gas is produced at the first anode, and substantially no bubbles of the second gas are formed at the first anode, or bubbles of the second gas are not formed at the first anode.

Advantageously in another example, in operation the first gas is produced at the second cathode, and substantially no bubbles of the first gas are formed at the second cathode, or bubbles of the first gas are not formed at the second cathode, and, the second gas is produced at the second anode, and substantially no bubbles of the second gas are formed at the second anode, or bubbles of the second gas are not formed at the second anode.

Preferably, the first cathode is gas permeable and liquid impermeable. In an example embodiment, the first cathode includes a first electrode at least partially provided by a gas-permeable and electrolyte-permeable conductive material, and, a first gas channel at least partially provided by a gas-permeable and electrolyte-impermeable material. In another example embodiment, the first gas can be transported in the first gas channel along the length of the first cathode. In another example embodiment, the second anode includes a second electrode at least partially provided by a gas-permeable and electrolyte-permeable conductive material, and, a second gas channel at least partially provided by a gas-permeable and electrolyte-impermeable material. The second gas can be transported in the second gas channel along the length of the second anode.

In an example, the first gas channel is positioned to be facing the second gas channel. In another example, the first gas channel and the second gas channel are positioned between the first electrode and the second electrode. The first cathode and the second anode can be planar. The second cathode and the first anode can also be planar. The first cathode can be flexible, and the second anode can also be flexible.

In example embodiments, there are also provided convenient and efficient configurations, arrangements, or designs for electrically connecting flexible leafs in series; i.e. a multi-electrode array, within a flat-sheet electrochemical cell, module or reactor, and where each flexible leaf comprises of a sealed gas channel or channels with its associated electrode or electrodes.

In one set of example embodiments, double-sided electrode leafs are used. The leafs comprise of two electrode material layers positioned on opposite sides of an electrode gas pocket, containing a gas channel spacer (i.e. a spacer material, layer or sheet, which, for example, can be made of a porous polymeric material) that provides a gas or fluid channel between the two electrodes. The resulting gas pocket within the leaf is typically equipped with a gas port. The current collectors on the top-side of the double-sided electrode leafs are placed so as to overhang their electrodes on one side of the leaf, while the current collectors on the bottom-side of the leafs are placed so as to overhang their electrodes on the opposite side of the leaf. When the resulting leafs are uniformly stacked into a flat-sheet, multi-leaf arrangement, separated by liquid-permeable ‘flow-channel’ spacers, then electrical connections are made by combining overhanging current collectors in pairs on either side of the stack. That is, the top electrode of one leaf is connected to the top electrode on the leaf above or below it, whilst the bottom electrodes of the two leafs are also separately connected to each other on the other side of the stack. This connection methodology is continued down the full length of the stack of leafs, so that all of the leafs in the stack are connected to another leaf in a pairwise arrangement. Multiple leafs connected by the approach result in a series electrical connection of the electrodes in the stack. When the volumes between the leafs are filled with a liquid or gel electrolyte, then the resulting cell is known as a “side-connected series cell”.

In further example embodiments, electrode leafs comprise of two separate, adjoining gas pockets, each having its associated porous electrode located on its outside (i.e. on the opposite side to the adjacent gas pocket). The resulting leaf, which may be flexible, then comprises of a layered arrangement having an electrode on its top, with one gas pocket below it, followed by a second, separate gas pocket below that, followed by a second electrode below it, on the bottom of the leaf. The gas pockets may each contain a gas-channel spacer within them to hold them up, and will typically each be equipped with a gas port. The two porous electrodes at the top and bottom of the leaf are then electrically connected to each other by, for example, metallic interconnections that pass through the two gas pockets, or that pass around the sides of the two gas pockets. The two gas pockets in each such leaf are sealed from each other, meaning that gas in one pocket is not able to pass into the adjoining pocket, and vice versa. Double-sided, double-gas pocketed leafs of this type are then stacked on top of each other with a liquid-permeable “flow-channel” spacer between them, to thereby create a multiple-leaf, series-connected “stack”. When the volumes between the leafs are filled with a liquid or gel electrolyte, then the resulting cell of this type is known as a “bipolar series cell”.

A key advantage that series-connected cells of this type have over comparable parallel-connected cells, such as the spiral-wound cells mentioned above, involves the way in which they are connected to their primary busbars.

The upper-most electrode of the upper-most leaf in each of the aforementioned stacks will typically be connected along its length to a primary busbar, which will typically take the form of a metallic bar that runs along one edge of the top of the stack. The lower-most electrode of the lower-most leaf will typically be separately connected along its length to a second primary busbar, which may take the form of a metallic bar that runs along one edge of the bottom of the stack. The two busbars will typically form the connection points (positive and negative poles) to which an external power supply will be connected. As noted above, because of the lower overall current and higher overall voltage of such a stack, each busbar will typically contain less metal and be smaller overall than a busbar in a comparable, parallel-connected stack of the same overall electrochemical active surface area at the same current density (such as a spiral-wound cell of the aforementioned type). Moreover, because the busbar are linear rods, they will typically also be simpler to connect to electrically using a means such as welding. There will typically not be a need to use complex techniques for busbar attachment, such as the aforementioned ‘Wedge Method’, ‘Bolted Wedge Method’, ‘Welded Wedge Method’, ‘Narrow or Wide Wedge Method’, ‘Powder Method’, ‘Sphere Method’, ‘Solder method’, ‘Continuous Wedge Method’, or ‘Spiral Method’.

In still further examples, series-connected leaf stacks may be wound into a spiral-wound cell. A “tricot” pack of porous flow-channel spacers may be constructed to accommodate a selected number of leafs, whose gas pocket/s are each equipped with a gas port, in a stack. The tricot pack and leafs are then wound about a central core element that has been adapted to connect the gas ports on each leaf to their relevant gas conduits within the core element. In the case where leafs comprising double-sided electrodes enclosing a single gas pocket are used, pairwise electrical connections of upper and lower electrodes on adjacent leafs are made on opposite sides of the leaf stack following the spiral winding, to thereby produce a “side-connected series cell” having a spiral-wound architecture. In the case where leafs comprising double-sided electrodes enclosing two adjacent gas pockets (with electrical interconnections between the upper and lower electrodes), the resulting assembly provides a “bipolar series cell” having a spiral-wound architecture.

These approaches provide for:
(1) An electrochemical cell for an electrochemical reaction, comprising:
   a stack of electrode leafs;
   separated from each other by intervening, electrically-insulating liquid-permeable spacers;
   wherein the individual leafs are connected to each other in a series electrical arrangement.
(2) An electrochemical cell for an electrochemical reaction, comprising:
   a stack of electrode leafs connected in electrical series; wherein:
   a primary busbar is electrically attached to the upper-most electrode in the upper-most leaf in the stack, and
   a separate primary busbar is electrically attached to the bottom-most electrode in the bottom-most leaf in the stack,
   wherein the busbar is of such size and such design as to provide for operation of the cell at high current density.

### Further Examples

The following further examples provide a more detailed discussion of particular embodiments. The further examples are intended to be merely illustrative and not limiting to the scope of the present invention.

### Example 1: Modelling a Water Electrolysis Cell of Present Embodiments, without a Separator/Diaphragm, at Atmospheric Pressure

In order to examine the dissolution of gas in a liquid electrolyte and its effect on crossover in a gas-liquid electrochemical cell, we have studied a water electrolysis cell containing two gas diffusion electrodes that is operated under conditions where bubbles are substantially not formed at the two electrodes. The cell facilitates electrochemical water-splitting, with half reactions as follows, in alkaline solution (containing aqueous potassium hydroxide, aq. KOH, as electrolyte):

Anode: 4OH⁻→O₂+2H₂O+4e⁻

Cathode: 2H₂O+2e⁻→H₂+2OH⁻ E_{cell}° 1.23 V

The cell makes use of two gas diffusion electrodes—an anode and a cathode—having relatively high wetting pressures, and which can be both gas-producing electrodes. The cell is further operated at 60° C. under conditions where bubbles of hydrogen are not, or are only minimally formed at the cathode, while bubbles of oxygen are not, or are only minimally formed at the anode. The cell further has no diaphragm between the electrodes; that is, there is no anion/cation-exchange membrane or any ion-permeable, gas-impermeable structure between the electrodes. There is no need for such a structure since there are substantially no bubbles formed and therefore there is no need to avoid mixing of gas bubbles by the presence of an ion-permeable, gas impermeable structure between the electrodes.

Under these circumstances, gas dissolution in the liquid electrolyte may negatively impact the energy and electrical efficiency of the cell in two ways:
(1) As noted in US20080160357, higher levels of dissolved gas and especially supersaturation of a dissolved gas, may increase the electrical resistance of the liquid electrolyte, which can only be overcome by the application of higher levels of electrical energy;
(2) Higher levels of dissolved gas may increase the incidence of gas produced at one electrode migrating through the liquid electrolyte to the other electrode (i.e. the phenomenon of ‘crossover’ by the migration of dissolved gases). At the other electrode, the gas may either:
   i. Be converted back into its original reactant, thereby decreasing the Faradaic efficiency of the system. In other words, electrons are consumed to manufacture the gas at one electrode and more electrons are then consumed to re-convert the gas back to its original reactant at the other electrode. Both sets of electrons consumed in these processes are wasted since they do not lead to a net output of gas. The Faradaic efficiency measures the percentage of electrons at each of the anode or cathode that are not wasted in this way. For example, hydrogen produced at the cathode from H₂O may dissolve in the liquid electrolyte and migrate to the anode, where the hydrogen is converted back into H₂O molecules. Also for example, oxygen produced at the anode from OH⁻ ions may dissolve in the liquid electrolyte and migrate to the cathode, where the oxygen is converted back into OH⁻ ions. The electrons involved in both the forward and the reverse processes are, effectively, wasted.
   ii. Pass through the other gas diffusion electrode, contaminating the gas produced at that electrode. For example, hydrogen formed at the cathode may dissolve in and migrate through the liquid electrolyte to the anode, where it may pass through the gas diffusion electrode and contaminate the oxygen formed at the anode. Similarly, oxygen produced at the anode may dissolve in and migrate through the liquid electrolyte to the cathode, where it may pass through the gas diffusion electrode and contaminate the hydrogen produced at the cathode.

Because the cell operates under bubble-free or substantially bubble-free conditions, it is possible to determine, relatively accurately, using modelling, the optimum conditions required in the cell to achieve maximum energy efficiency. Such modelling is only possible and can only be carried out with accuracy because it concerns a uniform liquid phase. Uniformly dispersed liquid phases of this type are amenable to independent characterisation of their physical properties. By contrast, when bubbles are present, the voids produced by the bubbles and the motion/size of the bubbles create non-uniformity which is, at the present time, almost impossible to accurately model.

To illustrate advantageous features of present embodiments, we now describe how the above electrochemical cell can be modelled. The model is based on empirical data published in the scientific literature that take into account the effect of external conditions, including the temperature, the concentration of KOH, and the extent of dissolution of the gases in the liquid electrolyte.

The effect of gas migration in the liquid electrolyte was modelled using Ficks law of diffusion, which holds only for uniform phases. Variations in specific gravity in the aqueous KOH solutions due to temperature, being relatively small, were not included in the model.

To model the hydrogen and oxygen solubilities in aqueous KOH solution of different concentrations, at different temperatures and at atmospheric pressure, we used data published in Russ J Phys Chem 1964, 44, 1146, which has been widely cited in the electrolysis literature. No alternative data could be found for hydrogen solubility in KOH solution. An alternative data set for oxygen solubility in KOH solution was available in Electrochim Acta 1967, 12, 287. Inspection of the oxygen solubility data in Electrochim Acta 1967, 12, 287 indicated solubilities that were quite similar at higher temperatures and KOH concentrations to that in Russ J Phys Chem 1964, 44, 1146, but somewhat lower at lower temperatures and KOH concentrations (up to ca. 25% lower). Since only oxygen solubility data was provided in Electrochim Acta 1967, 12, 287 and to be conservative (because it indicated higher solubilities for oxygen), we used the oxygen and hydrogen solubilities in Russ J Phys Chem 1964, 44, 1146.

The data for oxygen and hydrogen solubilities in aqueous KOH solution of different concentrations at different temperatures and at atmospheric pressure in Russ J Phys Chem 1964, 44, 1146 was digitized. Curve fitting was done using 2^{nd} order polynomials, which gave a reasonably reliable fit with the published data.

In order to model the diffusion coefficients of hydrogen and oxygen in aqueous KOH solution of different concentrations at different temperatures and at atmospheric pressure, we used the data published in FIGS. 2 and 3 in J Phys Chem 1970, 74, 1747. Alternative data for oxygen diffusion was also available in Acta Phys Chim Sinica 2015, 31, 1045. That data appeared to closely match the data in J Phys Chem 1970, 74, 1747.

The plots in FIGS. 2 and 3 in J Phys Chem 1970, 74, 1747 were digitized and curve fitting was done using 3^{rd} order polynomials. The curve fits were found to give a reasonably reliable fit with the published data up to and including ca. 50 wt % KOH (ca. 13.5 M) and 25-70° C. Modelling was also trialled using 4^{th} order polynomials. These gave a more accurate fit of the published data at many points, but also appeared to produce inconsistent data at other points. For this reason, the 3^{rd} order polynomial was considered more reliable overall.

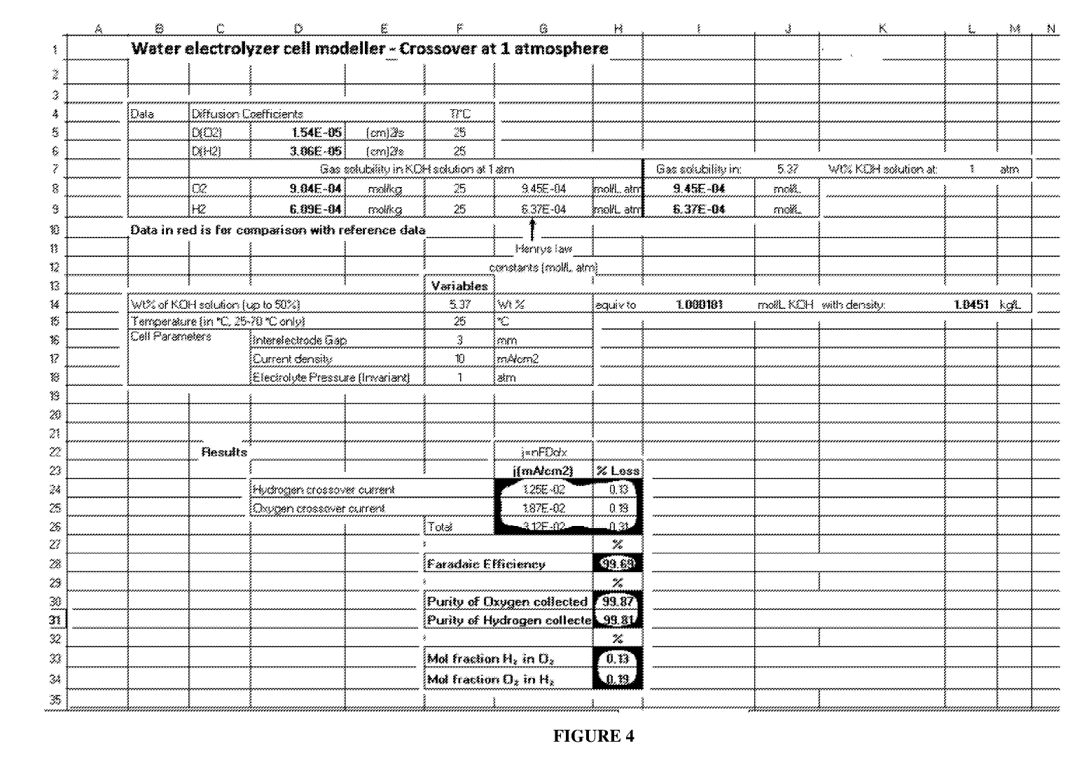

FIG. 4 depicts parameters and data produced from the spreadsheet model that was developed. The model allowed for a prediction of oxygen and hydrogen gas solubility and diffusion rates in aqueous solutions containing KOH of differing molarity and at different temperatures. The solubility data and diffusion rates were further used to calculate the extent of ‘crossover’ due to the migration of dissolved gases in the cell at different KOH concentrations, temperatures, inter-electrode spacings, and current densities.

Modelling using the spreadsheet showed that oxygen and hydrogen dissolution in the aqueous KOH electrolyte was disfavoured and diminished by:
(1) Higher KOH concentration. This effect is known as “salting out” of the gases and has been the subject of several studies.
(2) Higher temperature. This effect is consistent with kinetic theory, which predicts that the increased kinetic energy associated with higher temperatures causes more motion in the gas molecules, resulting in increased rates of their escape from the liquid solution.

The relative effects of the above processes on the system could be gauged by comparing the oxygen and hydrogen solubilities at the higher temperatures and KOH concentrations. Thus, for example, the maximum dissolved hydrogen decreased from 0.000637 mol/L in 1 M KOH at 25° C., to 0.000157 mol/L in 6 M KOH at 25° C., to 0.000124 mol/L at 6 M KOH at 60° C. The oxygen solubility similarly decreased from 0.000945 mol/L in 1 M KOH at 25° C., to 0.000129 mol/L in 6 M KOH at 25° C., to 0.000122 mol/L at 6 M KOH at 60° C.

Clearly, if the aim is to decrease the amount of dissolved hydrogen and oxygen present in the liquid electrolyte within the cell, then it is beneficial to operate at high KOH concentration and high temperature. The question that then arises is: how high should the temperature and the KOH concentration be in order to achieve the greatest electrical efficiency in the cell?

To answer that question, one needs to consider the conductivity of the KOH electrolyte solution at different KOH concentrations and temperatures. One also needs to determine to extent of ‘crossover’ due to the migration of dissolved gases at different KOH concentrations and temperatures. To achieve maximum energy efficiency in the cell it is desirable to operate under conditions where the conductivity of the KOH solution is the greatest feasible, while the extent of ‘crossover’ is at the lowest feasible. Without accurate modelling, one cannot readily determine the optimum conditions under which both of these requirements may be simultaneously met.

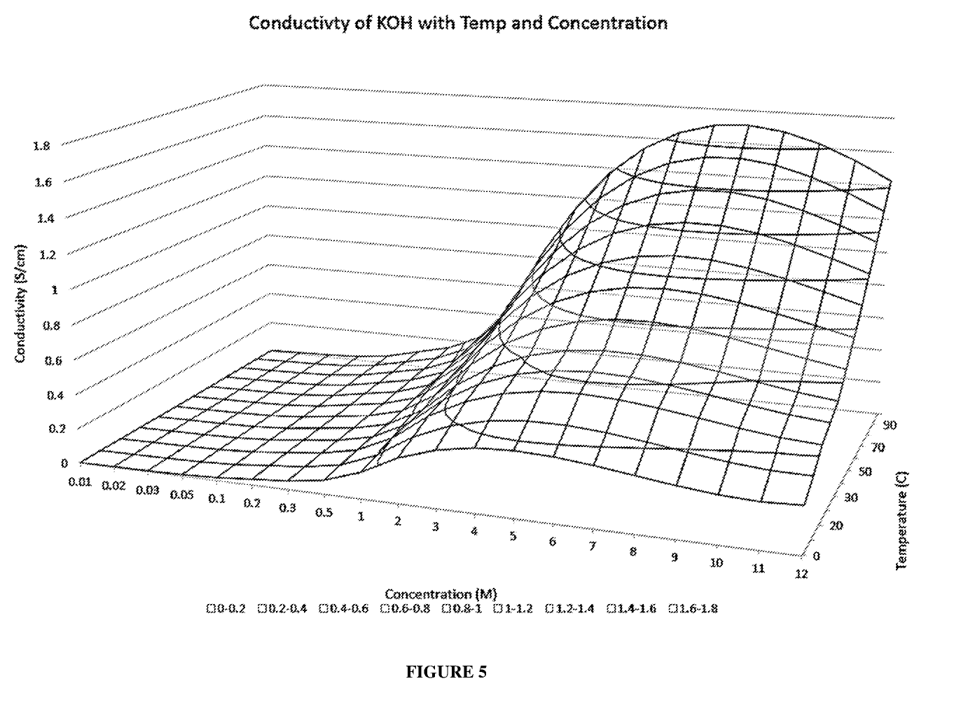

Data in respect of the conductivity of KOH electrolyte solutions at different KOH concentrations and temperatures (up to 90° C.) were found in Int. J. Hydrogen Energy 2007, 32, 359, which summarised all of the literature data available at that time. Additional data, which was substantially similar to that in Int. J. Hydrogen Energy 2007, 32, 359, was later published in Int. J. Hydrogen Energy 2012, 37, 16505. The data provided in Int. J. Hydrogen Energy 2007, 32, 359 was digitized and graphed. The graph of this data is presented in FIG. 5.

As can be seen in FIG. 5, the maximum electrical conductivity of a KOH solution occurs at 7-8 M KOH at 90° C. Given that the cell operated at 60° C., this temperature would provide the greatest feasible electrical conductivity if the KOH concentration was ca. 7 M.

So high a molarity and temperature is also conducive to very low levels of oxygen and hydrogen solubility, which, as noted above, are desirable. Thus, there is a potentially beneficial confluence in that high KOH concentration and temperature not only facilitates desirably low oxygen and hydrogen solubility, but also desirably high conductivity in the liquid electrolyte.

The question that now arises, and not previously considered, is: what is the effect of high KOH concentration and high temperature on ‘crossover’ due to the migration of dissolved gases in the cell?

To determine that question, we used Ficks' law for diffusion, applied to the published data for the oxygen and hydrogen diffusion coefficients, which had been incorporated into our model. In this way, we could calculate how fast the dissolved hydrogen and oxygen would migrate in the liquid electrolyte at different KOH concentrations and temperatures. To measure the rate of crossover, we included a setting for the size of the gap between the anode and cathode electrodes (the ‘inter-electrode distance’ in FIG. 4), and then calculated the crossover current densities for each of hydrogen and oxygen, arising from diffusion between the electrodes by dissolved hydrogen and oxygen.

We also set the operating current density of the cell (‘current density’ in FIG. 4) and then calculated the crossover currents as a percentage of the overall operating current density of the cell. The results of this calculation were presented at the bottom of the spreadsheet model shown in FIG. 4, and detailed in terms of: (i) the minimum Faradaic efficiency of the system and (ii) the maximum percent contamination of each gas collected at its gas diffusion electrode with the other gas; that is, the maximum oxygen in the hydrogen collected at the cathode and the maximum hydrogen in the oxygen collected at the anode.

Two countervailing trends could be discerned in respect of ‘crossover’ due to the migration of dissolved gases in a cell having a 3 mm inter-electrode spacing and an operating current density of 10 mA/cm².

The first was that as the temperature increased, the amount of crossover also increased. For example, at a constant 1 M KOH, the minimum Faradaic efficiency went from 99.7% at 25° C. to 99.6% at 40° C., to 99.4% at 60° C. This arose because, although the amount of dissolved hydrogen and oxygen in the KOH solution decreased as the temperature rose, the rates of diffusion of the dissolved gases increased to thereby counteract that effect. That is, the effect of the increased diffusion rate overwhelmed the effect of the lower quantities of dissolved gases present as the temperature was increased. Increasing the temperature of the cell therefore increased the rate of crossover and thereby counteracted the desirable effects of higher temperature noted earlier.

The second trend was better aligned with the earlier-mentioned desirable effects. An increase in the KOH concentration was found to diminish crossover due to the migration of dissolved gases. Thus, at a constant 25° C., the minimum Faradaic efficiency decreased from 99.7% at 1 M KOH, to 99.8% at 2 M KOH, to 99.9% at 4 M KOH, to 100% at 6 M KOH. That is, increasing the KOH concentration decreased the extent of crossover due to dissolved gases, which aligned with the desirable effects of high KOH concentration noted earlier.

In effect therefore, high KOH concentration produced desirable results in terms of: (i) the amount of dissolved hydrogen and oxygen present in the liquid electrolyte, (ii) the electrical conductivity of the liquid electrolyte, and (iii) the extent of crossover. But high temperature produced desirable results for only (i)-(ii) above and undesirable results for (iii).

The model showed however, that, for a 3 mm inter-electrode gap and a 10 mA/cm² operating current density, the undesirable effects of high temperature in respect of crossover by dissolved gases were more than overcome by the desirable effects of high KOH concentration. Thus, the minimum Faradaic efficiency of 99.7% at 1 M KOH and 25° C. increased to an acceptable maximum 99.97% at 7 M KOH and 60° C. That is, the most optimum possible crossover could be achieved at high temperature and high KOH concentration.

Accordingly, the cell would operate most energy efficiently at atmospheric pressure if the liquid electrolyte had a KOH concentration of 7 M when the operating temperature was 60° C.

The model moreover, allowed for the determination of the ideal cell configuration under different conditions and circumstances. For example, if it was, for some reason, impossible to use KOH solution of concentration greater than 1 M and to operate at a temperature no higher than 25° C., then one could still achieve 100% minimum Faradaic efficiency by employing a 10 mm inter-electrode gap instead of a 3 mm one. Alternatively, one could operate the cell at a current density of 40 mA/cm² instead of 10 mA/cm², with a 3 mm inter-electrode gap in order to achieve 100% minimum Faradaic efficiency.

### Example 2: New Features for Electrolyzers and Alkaline Electrolyzers

The above results demonstrate new features for electrolyzers and alkaline electrolyzers. These features may be applied in example electrochemical cells as described herein, including but not limited to cells of the types described in WO2013/185170, WO2015/013764, WO2015/013765, WO2015/013766, WO2015/013767, WO2015/085369, and in the Applicant's concurrent International Patent Applications entitled “Electrochemical cell and components thereof capable of operating at high current density” and “Electrochemical cell and components thereof capable of operating at high voltage”, filed on 14 Dec. 2016.

Firstly and most fundamentally, it is worth comparing the effect on the overall electrical and energy efficiency of having a liquid electrolyte between the electrodes as taught in this application, compared to a solid-state ion-exchange membrane, such as a proton exchange membrane (PEM), as has been widely used elsewhere. As noted earlier, ion-exchange membranes became attractive in gas-liquid cells because they potentially avoided or minimised the issues of voidage, the bubble curtain effect and the bubble overpotential that exist in conventional alkaline electrolyzers.

A useful measure of the relative energy efficiencies of the two situations is to calculate and compare the ohmic voltage drop between the electrodes in: (i) a typical example alkaline electrolyzer of present embodiments, and (ii) a typical commercial PEM electrolyzer. The smaller the voltage drop, the higher the relative energy and electrical efficiency of the cell. The voltage drop between the electrodes can be calculated using Ohm's law:

ΔV=il/σ

where:
ΔV=the voltage drop (in V)
i=the current density (in A/m²)
l=the interelectrode separation (in m)
σ=the conductance (in S/m)

If one now considers a typical example “bubble-free” alkaline electrolyzer of a present embodiment having a 3 mm inter-electrode gap and operating economically-viably at a current density of 50 mA/cm² at 80° C. using aqueous 6 M KOH (σ 1.349 S/cm) as a liquid electrolyte between the electrodes, then the ohmic voltage drop between the electrodes is calculated as:

$$\begin{matrix}Δ V = 0.05 ( \frac{A}{cm 2} ) \times 3 \times {10}^{- 3} ( m ) \times 100 ( \frac{cm}{m} ) / 1.349 ( \frac{1}{Ω cm} ) \\ = 0.011 V\end{matrix}$$

If we consider, by contrast, a conventional PEM electrolyzer utilizing a solid-state Nafion 117 PEM membrane (185 μm thickness; immersed in water) between the electrodes and operating at a typical current density of 1.8 A/cm² at 80° C., then the conductance σ of the membrane is 0.1454 S/cm, at least according to FIG. 2 in the scientific paper entitled: “Properties of Nafion membranes under PEM water electrolysis conditions” by H. Ito, T. Maeda, A. Nakano, and H. Takenda, published in the International Journal of Hydrogen Energy, Vol 36 (2011), pages 10527-10540. The ohmic voltage drop between the electrodes will then be:

$$\begin{matrix}Δ V = 1.8 ( \frac{A}{cm 2} ) \times 185 \times {10}^{- 6} ( m ) \times 100 ( \frac{cm}{m} ) / 0.1454 ( \frac{1}{Ω cm} ) \\ = 0.229 V\end{matrix}$$

Thus, a typical example alkaline electrolyzer of a present embodiment will experience a substantially smaller voltage drop and therefore a substantially higher intrinsic electrical and energy efficiency than a typical conventional PEM electrolyzer.

Even if the conventional PEM electrolyzer were operated at one-twentieth of its normal, operational current density (i.e. at 90 mA/cm²), which would likely be economically unviable, it would still experience a larger voltage drop across its electrodes than would the above alkaline electrolyzer of a present embodiment.

Thus, present embodiments provide means to improve upon the energy efficiency of conventional alkaline electrolyzers and also upon alternative systems such as ones based on solid-state, ion-exchange membranes between the electrodes.

Secondly, it is apparent from the above description that, all other variables including pressure being constant, increases in current density in a cell of the present embodiments lead to increases in the relative purities of the gases produced. This is especially true, at higher current densities. Thus, even in circumstances where crossover due to the migration of dissolved gases would be substantial and an impediment to the safe operation of an alkaline electrolyzer, that limitation may be removed by merely operating the cell at higher current densities. This is because the rate of crossover of the type present in cells of the aformentioned type is fixed by the solubilities of the gases involved in the liquid electrolyte and their rates of diffusion. As a result, this form of crossover may be relatively easily swamped by merely increasing the overall rate of gas production.

This feature may also be found, albeit to a lesser extent, in conventional PEM electrolyzers and in conventional alkaline electrolyzers when the separator (diaphragm) is fully wetted and able to avoid bubbles lodging in its pores. However, in conventional alkaline electrolyzers, increases in current density lead to a rapid increase in electrolyte resistance due to voidage and bubble curtain effects, with a concomitant decrease in electrolyte conductance and overall energy efficiency.

Electrolyzers of the current specification are not limited in the same way, or at least not to the same extent. Increases in current density do not lead to sharply increased electrolyte resistance, even at very high current densities, all other variables being maintained constant.

Thus, the constraint that conventional alkaline electrolyzers labour under, namely, of decreasing electrical efficiency due to a higher voltage drop between the electrodes with increased current density, is removed or, at least, drastically mitigated. In other words, whereas the purity of the gases produced by a conventional alkaline electrolyzer may potentially be improved by increasing the current density, this would be paid for by drastically lower energy efficiency. The practical effect was that conventional alkaline electrolyzers were typically limited to operating at current densities of no more than ca. 300 mA/cm² (at potentials near 2 V), with system efficiencies near 60%. No such constraints apply to the new modes of operation of example electrochemical cells as described herein and in the Applicant's concurrent International Patent Applications entitled “Electrochemical cell and components thereof capable of operating at high current density” and “Electrochemical cell and components thereof capable of operating at high voltage”, filed on 14 Dec. 2016.

Alkaline electrolyzer cells of the present embodiments also enjoy other advantages relative to conventional alkaline electrolyzers. Included amongst these is a reduced need to pump the electrolyte through the chambers between the electrodes. In the absence of bubbles there is a lesser need to have electrolyte sweeping over the surface of the electrode.

Similarly, whereas conventional alkaline electrolyzers are not well-suited to sudden and large increases in current because of the pressure burst hazard associated with rapid bubble formation and other issues, alkaline electrolyzer cells of the aforementioned type do not form bubbles and are therefore able to better handle large and sudden increases in current.

### Example 3: Modelling a Bubble-Free Water Electrolysis Cell at High Pressure

In order to examine how the dissolution of gas in a liquid electrolyte is affected by the application of pressure to the liquid, we have also modelled the electrolyzer cell from the previous example in this respect.

No published data could be found for the solubilities of oxygen and hydrogen in aqueous potassium hydroxide (KOH) solution at different pressures and temperatures. Modelling had therefore to be done using theoretical approaches and the available data for pure water, not containing any KOH.

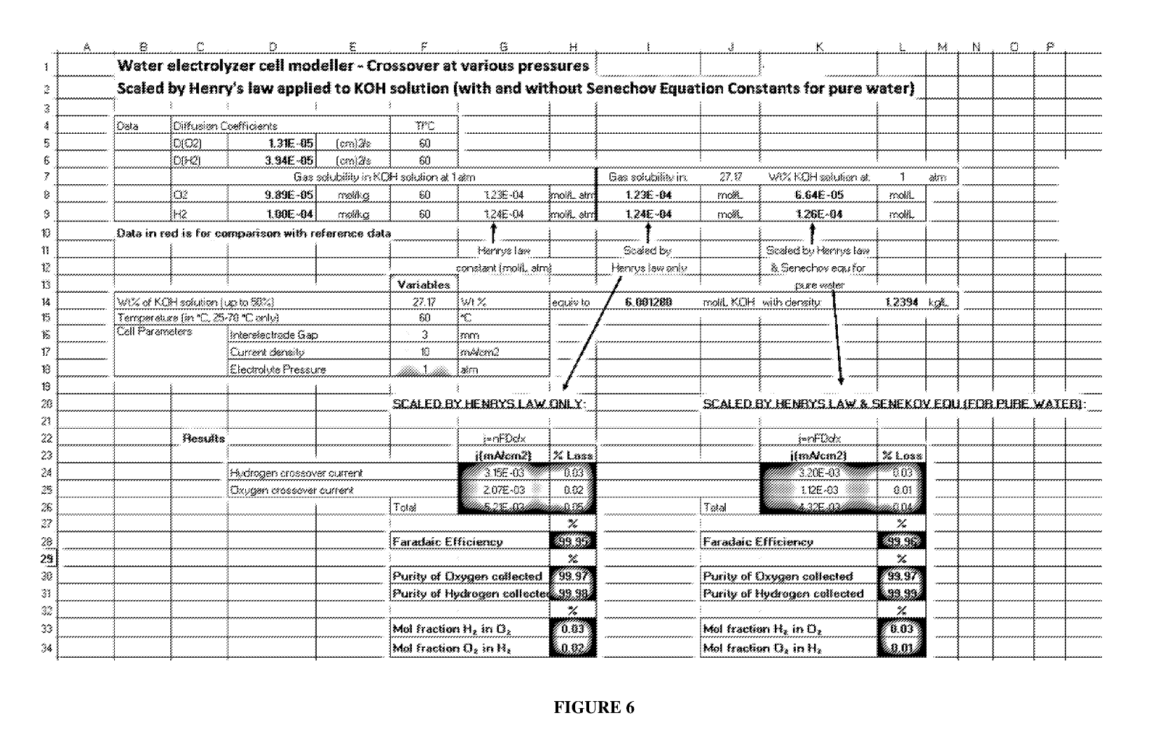

Two approaches were used. The first employed Henrys' law, which describes how the solubility of a gas in a liquid changes as a function of applied pressure on the liquid. Henrys' law was applied to the solubilities of hydrogen and oxygen in an aqueous solution as a function of temperature and KOH concentration. FIG. 6 depicts parameters used and data produced from the model that was developed, showing, in column I, line 8-9, the calculated solubilities of oxygen and hydrogen in the KOH solution, at the set pressure and temperature.

The model thus obtained was tested by setting the KOH concentration to zero (that is, using pure water as the electrolyte). The calculated hydrogen and oxygen solubility data were then compared with published data for pure water at particular higher temperatures and pressures. This comparison indicated that the calculated data became somewhat too high relative to the published data as the temperature increased. A correction factor was required.

A second approach was therefore developed which employed a normalisation (at 25° C.) of the Henrys' law constant for different temperatures using the Senechov equation constants for pure water. The model (FIG. 6) depicts the calculated solubilities of oxygen and hydrogen in the KOH solution, at the set pressure and temperature, in column K, lines 8-9.

When tested by setting the KOH concentration to zero (that is, using pure water as the electrolyte), the hydrogen and oxygen solubilities calculated using this approach proved to more closely match, but to slightly undershoot, the published data for pure water at particular higher temperatures and pressures.

Thus, the first approach yielded solubility data that slightly overshot the published data for pure water, while the second approach generated data that slightly undershot it. The two approaches appear to effectively bracket the solubility data at pressure, between an upper and a lower limit. Based on the available data for pure water, it is expected that the actual data for KOH solution will likely fall inside the range created by the above upper and lower limits.

As in the previous example, we used Ficks' law for diffusion, applied to the data generated by the model for oxygen and hydrogen solubilities and diffusion rates, to calculate the rate at which dissolved hydrogen and oxygen would migrate from one electrode to the other in the liquid electrolyte, at different KOH concentrations, temperatures and pressures. To measure the rate of crossover, we included a setting for the size of the gap between the anode and cathode electrodes (the ‘inter-electrode gap in FIG. 6), and then calculated the crossover current densities for each of hydrogen and oxygen, arising from diffusion between the electrodes by dissolved hydrogen and oxygen.

We also provided a setting for the operating current density of the cell (‘current density’ in FIG. 6) and then calculated the crossover currents as a percentage of the overall operating current density of the cell.

We used the data generated by the two different approaches discussed above to calculate two different outcomes, depicted in lines 28-31 for column H (first approach) and column L (second approach). As in the previous example, these results are presented in terms of: (i) the minimum Faradaic efficiency of the system and (ii) the minimum purity of each gas collected at its gas diffusion electrode (with contamination assumed to be with the other gas; that is, the oxygen contamination in the hydrogen collected at the cathode and the hydrogen contamination in the oxygen collected at the anode). To illustrate the key effects, graphs were drawn up using data generated by the model.

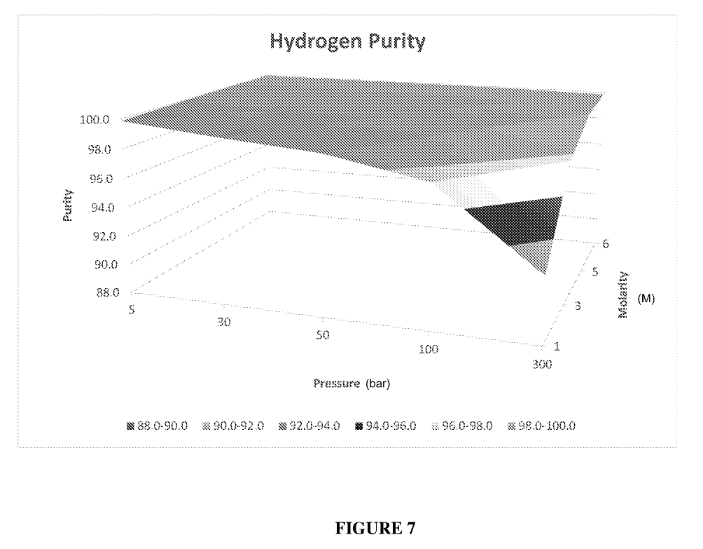

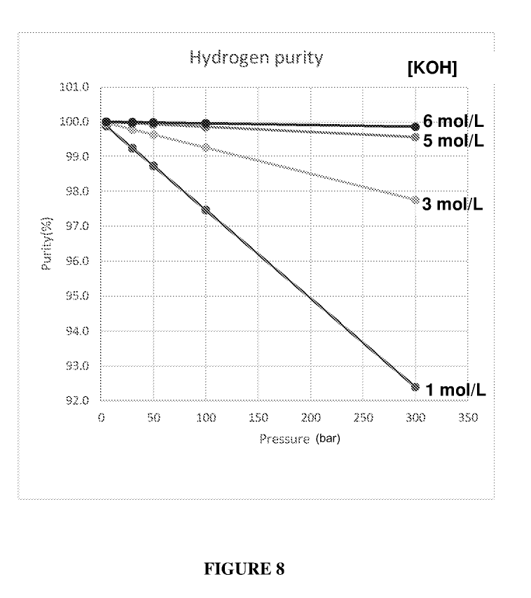

FIG. 7 shows the calculated minimum purity of the hydrogen collected at the cathode as a function of the applied pressure and the KOH concentration when the current density is 50 mA/cm², the inter-electrode distance is 5 mm, and the temperature is 50° C. As can be seen with 6 M KOH, the expected minimum hydrogen purity remains high, even up to a pressure of 300 bar. FIG. 8 shows how the calculated minimum hydrogen purity varies up to 300 bar for different KOH concentrations. As can be seen, even at 300 bar, the expected minimum hydrogen purity is very close to 100% if 6 M KOH is used as the electrolyte.

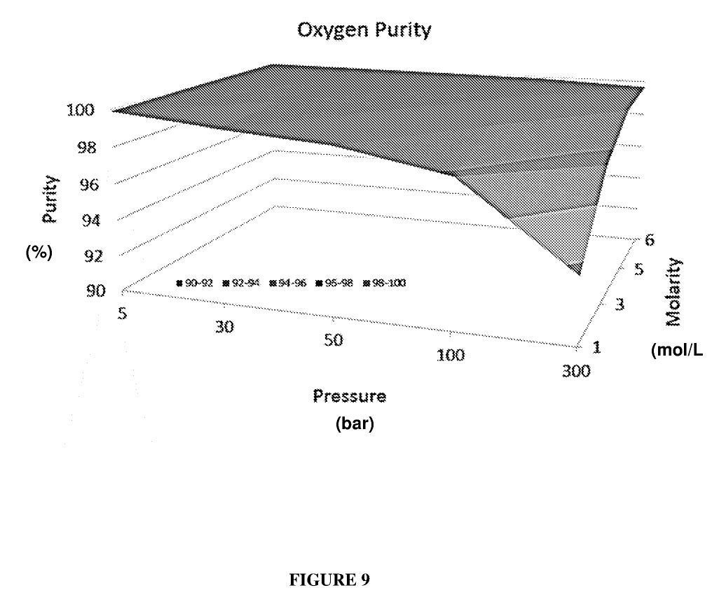

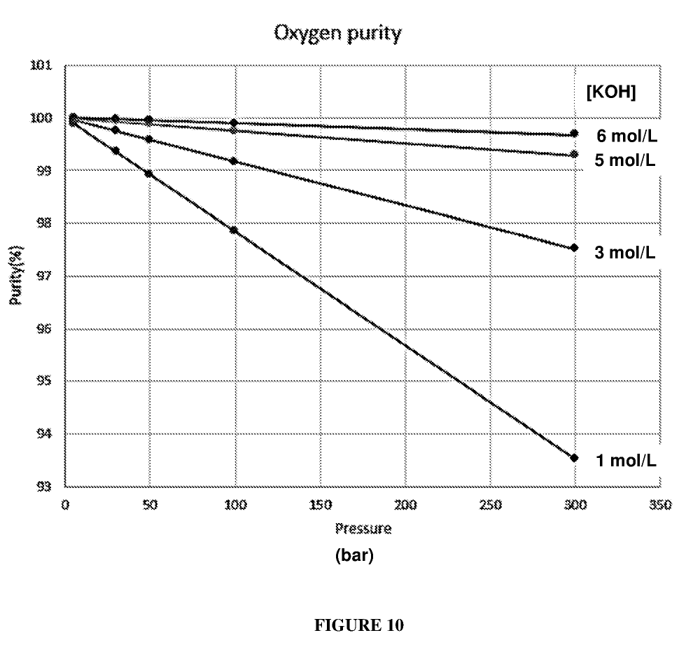

FIG. 9 depicts the calculated minimum purity of the oxygen collected at the anode under the same conditions, as a function of the applied pressure and the KOH concentration. As can be seen with 6 M KOH, the expected minimum oxygen purity remains high, even up to a pressure of 300 bar. FIG. 10 shows how the calculated minimum oxygen purity varies up to 300 bar for different KOH concentrations. As can be seen, even at 300 bar, the expected minimum oxygen purity is more than 99.7%.

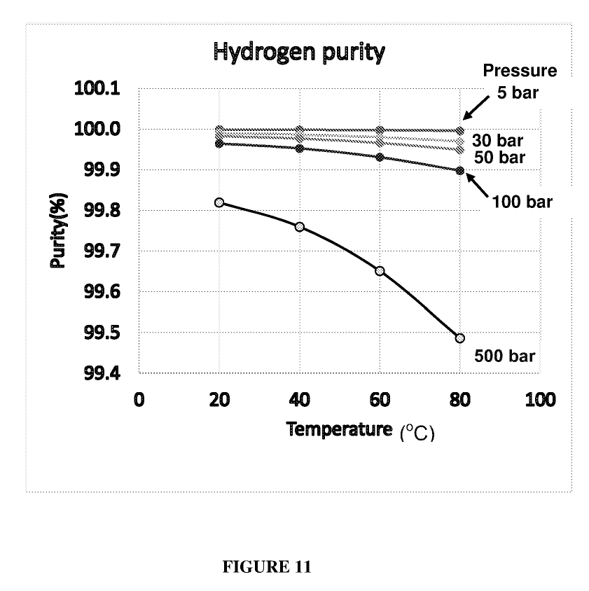

FIG. 11 depicts the calculated minimum purity of the hydrogen collected at the cathode as a function of the applied pressure and the temperature when the current density is 50 mA/cm², the inter-electrode distance is 5 mm, and the KOH concentration is 6 M. As can be seen even at 500 bar and at 80° C., the expected minimum hydrogen purity is calculated to be 99.5%.

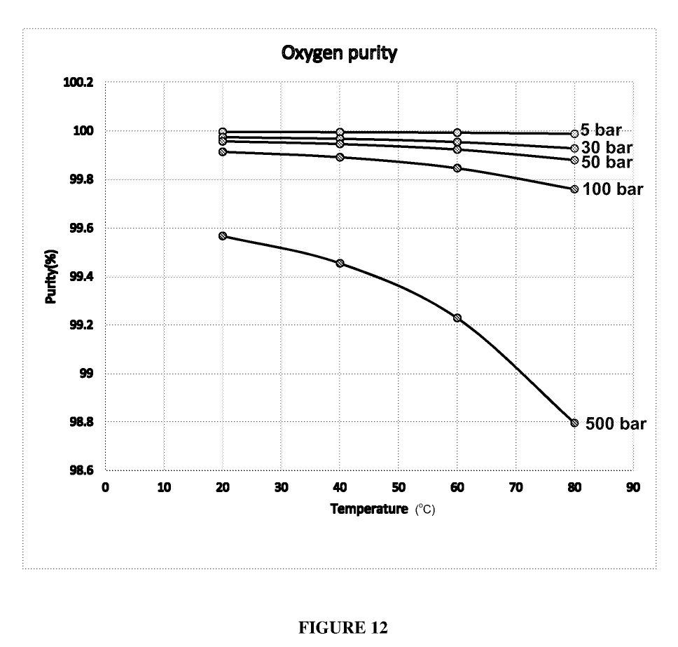

FIG. 12 depicts the calculated minimum purity of the oxygen collected at the anode as a function of the applied pressure and the temperature when the current density is 50 mA/cm², the inter-electrode distance is 5 mm, and the KOH concentration is 6 M. As can be seen even at 500 bar, the expected minimum oxygen purity is calculated to be 98.8%.

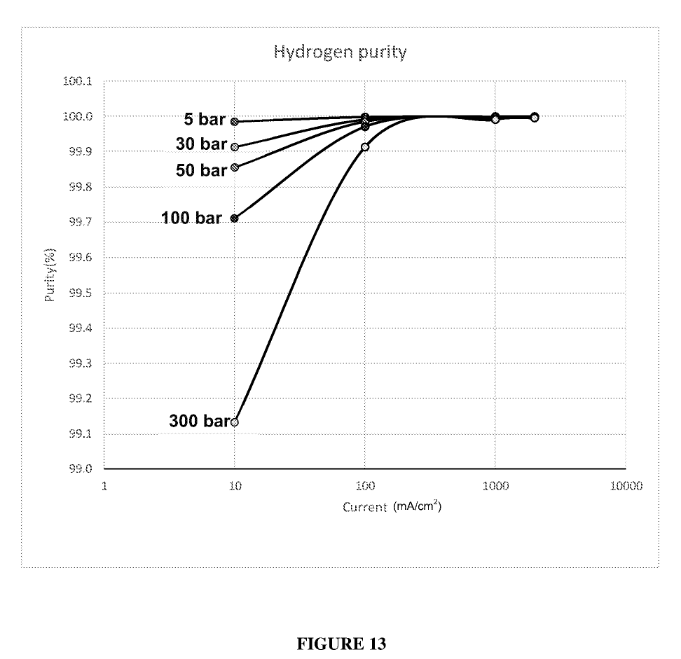

FIG. 13 depicts the calculated minimum purity of the hydrogen collected at the cathode as a function of the current density and the applied pressure when the temperature is 50° C., the inter-electrode distance is 5 mm, and the KOH concentration is 6 M. As can be seen the expected minimum purity of the hydrogen collected is more than 99% even at 300 bar and 10 mA/cm², but this increases to close to 100% as the current density increases. At 300 bar and 100 mA/cm², it is more than 99.9%.

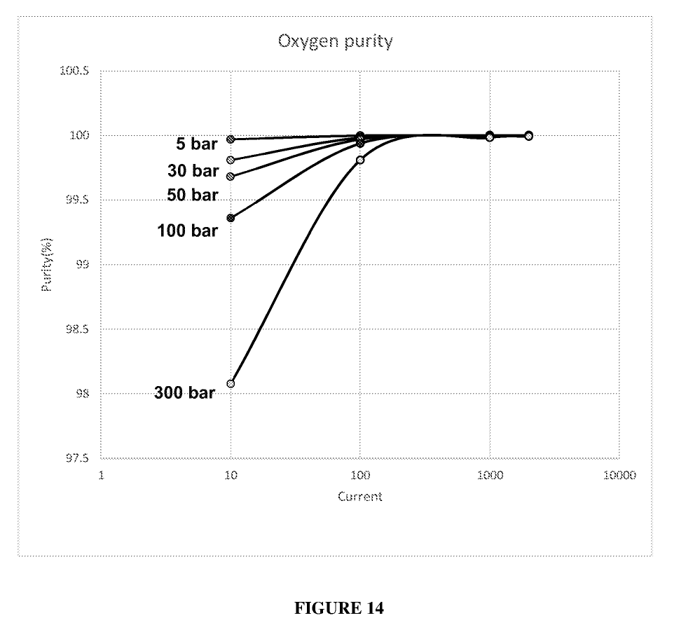

FIG. 14 depicts the calculated minimum purity of the oxygen collected at the anode as a function of the current density and the applied pressure when the temperature is 50° C., the inter-electrode distance is 5 mm, and the KOH concentration is 6 M. As can be seen the expected minimum purity of the oxygen collected is more than 98% at 300 bar and 10 mA/cm², but this increases to close to 100% as the current density increases. At 300 bar and 100 mA/cm², it is more than 99.8%.

### Example 4: Empirical Assessment of the Modelling

To check the modelling above, a spiral-wound cell of the type described in WO2013/185170, and fabricated using means described in WO2015/085369 and in the Applicant's concurrent International Patent Applications entitled “Electrochemical cell and components thereof capable of operating at high current density”, filed on 14 Dec. 2016, was constructed and used for empirical testing.

A flat-sheet cell (incorporating 5 individual cells connected in electrical series) of the type described in the Applicant's concurrent International Patent Applications entitled “Electrochemical cell and components thereof capable of operating at high voltage”, filed on 14 Dec. 2016, was also constructed and used for empirical testing.

Both of the above cells employed a 3 mm inter-electrode gap, without a diaphragm, and used 6 M KOH as electrolyte. The cells were operated under the following conditions:
(1) Spiral-wound and series cell: 10 mA/cm²; 25° C.; 0.5 bar electrolyte pressure; gases collected at atmospheric pressure
(2) Spiral-wound cell only: 10 mA/cm²; 55° C.; 30 bar electrolyte pressure; gases collected at 29.5 bar pressure

The following table summarizes the purity of the gases collected directly off-the-stack under the above conditions by the two cells:

TABLE 2
Gas purity data for two cells of the present embodiments

| | | | | Condition (2) | |
|---|---|---|---|---|---|
| | Condition (1) | | | | Actual |
| | | Actual Measured | | | Measured |
| | Expected | Purity¹ | | Expected | Purity² |
| | from | Spiral | Series | from | Spiral |
| | Modelling | Cell | Cell | Modelling | Cell |
| Purity of | 99.99% | 99.989% | 99.952% | 99.98% | 99.9% |
| Hydrogen | | | | | |
| Purity of | 99.98% | 99.141% | 99.250% | 99.97% | 98.5% |
| Oxygen | | | | | |

¹Measured using a calibrated gas chromatograph (detection limit: 99.995%)
²Measured using flow meter (detection limit: 99.9%)

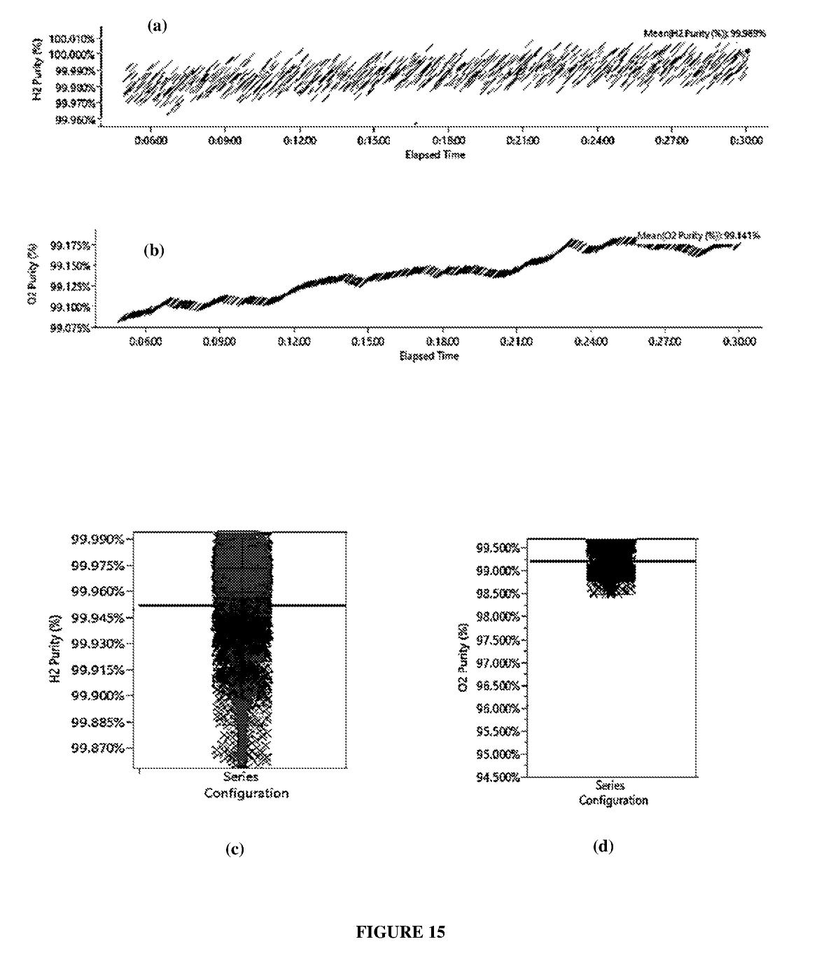

FIG. 15(a)-(b) depicts the hydrogen and oxygen purity data for the above spiral-wound cell under condition (1) over a period of operation. FIG. 15(c)-(d) depicts the hydrogen and oxygen purity data for the above series cell under conditions (1) over a period of operation.

As can be seen, the empirically measured data displayed an excellent fit with the expected results from the modelling for the hydrogen purity. The oxygen purity data provided a somewhat poorer fit, especially at 30 bar applied pressure. However, increasing the current density to 50 mA/cm² notably increased the oxygen purity.

The significance of this data is revealed by comparing it with data for PEM electrolyser cells, as reported in the scientific paper entitled: “Properties of Nafion membranes under PEM water electrolysis conditions” by H. Ito, T. Maeda, A. Nakano, and H. Takenda, published in the International Journal of Hydrogen Energy, Vol 36 (2011), pages 10527-10540. That work compiled and compared gas purity data from a number of studies of PEM electrolyzers. At atmospheric pressure, a typical PEM electrolyser operating at full current density (presumably 1,000-1,800 mA/cm²) produced hydrogen of ca. 99.9% purity at the cathode, which is comparable to the data in Table 2. That purity fell to ca. 99.6% at 30 bar, which is slightly lower than, but still comparable to the data in Table 2. However, when the current density was reduced, the purity of the gases generated declined. At very low current densities, the decline was substantial. By 150 mA/cm², the proportion of hydrogen impurity in the oxygen that was generated was said to have increased by about 60%, from 0.5% to 0.8% hydrogen impurity. While the purity of the generated gases was not measured at very low current densities, extrapolation of the trend suggests that the comparable gas purities for the PEM electrolyzers at 10 mA/cm² and atmospheric pressure would be <99.5% for hydrogen and <98.0% for oxygen. At 30 bar, the purity of the gases at 10 mA/cm² may be projected to decline to <99% for hydrogen and <96% for oxygen. These data compare unfavourably with the data in Table 2, which is all the more remarkable for the fact that the data in Table 2 was obtained without the presence of any sort of solid state barrier between the electrodes. It can be concluded that it is clearly more successful to induce the gases into their respective gas pockets using the teachings of the present specifcation than to block them using a physical barrier such as a ion-permeable diaphragm or PEM membrane.

As noted on pages 122-123 in the book “Hydrogen Production by Electrolysis”, by A. Godula-Jopek (Wiley-VCH, 2015), the poor purity of the generated gases at very low current densities is, indeed, the reason that many electrolyzers, including most especially alkaline electrolyzers, must be kept operating at a minimum current density at all times (typically 10-20% of rated power). This is to avoid the gas purities approaching the lower explosion limit (LEL) of hydrogen in oxygen, which is 3.9 mol %, or the upper explosion limit (UEL), which is 95.8%. Beyond these limits, the gas mixtures become spontaneously explosive, creating a significant safety hazard.

### Example 5: Illustrating the Effect of the Invention

The example of conventional alkaline electrolyzers provides a means to illustrate the effect that the present invention can have in example embodiment electrochemical cells relative to existing electrochemical cells. Specifically, one may compare the extent of crossover (CO) in an example embodiment alkaline water electrolyser with present-day commercial alkaline electrolyzers, that as noted above, must be kept operating at a minimum current density to avoid the formation of explosive mixtures of hydrogen and oxygen (having >3.9 mol % of oxygen in the hydrogen or hydrogen in the oxygen). For the purposes of comparison, reasonable conditions may be chosen for the conventional alkaline electrolyzers; namely continuous operation at 10-20% of the rated power, which would typically equate to 10-20% of 400-600 mA/cm². For the purposes of the comparison, the minimum current density will be set generously, to 50 mA/cm². The cell width (inter-electrode gap) can also be considered to be ca. 30 mm, with the pressure and temperature set at atmospheric pressure and 60° C. Many commercial alkaline electrolyzers operate at 10-30 bar pressure so using atmospheric pressure is also generous and non-demanding. These conditions would then represent the limit at which typical conventional alkaline electrolyzers can be operated safely. That is, at atmospheric pressure and 60° C., with either an inter-electrode gap less than 30 mm (at a current density of 50 mA/cm²) or with a current density less than 50 mA/cm² (at a fixed inter-electrode gap of 30 mm), typical conventional alkaline electrolyzers would generate crossover of 4% or more, making them unsafe.

Table 3 shows the comparable data for an example embodiment alkaline electrolyser at 60° C., and atmospheric pressure, with a 30 mm or less inter-electrode gap, operating at 50 mA/cm² or less using the optimised electrolyte conditions of 7 M KOH.

TABLE 3
Crossover data for example embodiment cells (modelled) relative to present-
day commercial alkaline electrolyzers.

| | | | | Crossover in | Crossover in a |
|---|---|---|---|---|---|
| | | | | Example | Typical |
| | | | Inter- | Embodiment | Commercial |
| | | Current | electrode | Alkaline | Alkaline |
| Temperature | Pressure | Density | gap | Electrolyzer | Electrolyzer |
| 60° C. | 1 bar | 50 mA/cm² | 30 mm | (<1%) safe | safe |
| | | 30 mA/cm² | | (<1%) safe | (>4%) UNSAFE |
| | | 15 mA/cm² | | (<1%) safe | unsafe |
| | | 5 mA/cm² | | (<1%) safe | unsafe |
| | | 1 mA/cm² | | (<1%) safe | unsafe |
| | | 0.1 mA/cm² | | (<1%) safe | unsafe |
| | | 0.003 mA/cm² | | (5%) UNSAFE | unsafe |
| 60° C. | 1 bar | 50 mA/cm² | 30 mm | (<1%) safe | safe |
| | | | 25 mm | (<1%) safe | (>4%) UNSAFE |
| | | | 10 mm | (<1%) safe | unsafe |
| | | | 5 mm | (<1%) safe | unsafe |
| | | | 3 mm | (<1%) safe | unsafe |
| | | | 1 mm | (<1%) safe | unsafe |
| | | | 0.25 mm | (1.5%) safe | unsafe |
| | | | 0.1 mm | (3%) safe | unsafe |
| | | | 0.05 mm | (6%) UNSAFE | unsafe |

As can be seen from Table 3, whereas, in the best case scenario, the above typical present-day commercial alkaline electrolyzers become unsafe (4% crossover) if their current density falls below 50 mA/cm² at a fixed inter-electrode distance of 30 mm, example embodiment alkaline electrolyzers only become unsafe if their current density falls below 0.1 mA/cm². Moreover, whereas the above typical present-day commercial alkaline electrolyzers become unsafe (4% crossover) if their inter-electrode distance is smaller than 30 mm at a fixed current density of 50 mA/cm², example embodiment alkaline electrolyzers only become unsafe if their inter-electrode distance is smaller than 0.1 mm at a fixed current density of 50 mA/cm². This occurs despite the fact that conventional electrolyzers have an ion-permeable, gas-“impermeable” diaphragms between their electrodes, while example embodiment alkaline electrolyzers have no physical barrier between their electrodes.

A further illustration of the effect of the invention can be made by comparing example embodiment alkaline electrolyzers at pressure with and without optimization of the taught type.

TABLE 4
Crossover data for embodiment cells (modelled) under optimized (using 7M
KOH electrolyte) and un-optimized conditions (using 0.01M KOH).

| | | | | Crossover in | Crossover in |
|---|---|---|---|---|---|
| | | | | Example | Example |
| | | | | Embodiment | Embodiment |
| | | | | Alkaline | Alkaline |
| | | | | Electrolyzer | Electrolyzer using |
| | | | Inter- | using optimized | un-optimized 0.01M |
| | | Current | electrode | 7M KOH | KOH |
| Temperature | Pressure | Density | gap | electrolyte | electrolyte |
| 60° C. | 10 bar | 3 mA/cm² | 25 mm | <1% | 2% |
| | | | 10 mm | <1% | 5% |
| | | | 5 mm | <1% | 9% |
| | | | 3 mm | <1% | 14% |
| | | | 1 mm | 1% | 33% |
| 60° C. | 30 bar | 3 mA/cm² | 25 mm | <1% | 6% |
| | | | 10 mm | <1% | 13% |
| | | | 5 mm | 1% | 23% |
| | | | 3 mm | 2% | 33% |
| | | | 1 mm | 3% | 59% |
| 60° C. | 200 bar | 3 mA/cm² | 25 mm | 1% | 28% |
| | | | 10 mm | 2% | 49% |
| | | | 5 mm | 3% | 66% |
| | | | 3 mm | 6% | 76% |
| | | | 1 mm | 17% | 91% |

Table 4 illustrates the crossover (CO) for an example embodiment electrolyser under optimized conditions (using 7 M KOH electrolyte) and under non-optimized conditions (using 0.01 M KOH electrolyte). As can be seen, the crossover is substantially lower under all of the conditions shown when the electrochemical cell has been optimized relative to its unoptimized state. Thus, for example, at a temperature of 60° C. and 10 bar pressure, with the current density set to 3 mA/cm² and the inter-electrode gap set to 1 mm, the un-optimized system has a crossover of 33%, while the optimized system has a crossover of only 1%. These difference are still further amplified at higher pressures.

Thus, in another example aspect, a current density is selected at least partially based on an inter-electrode distance between the electrodes, to produce a crossover for the electrochemical cell. In one example, the current density is greater than or equal to 3 mA/cm², the inter-electrode distance is greater than or equal to 1 mm, and the crossover is less than or equal to 40%, 35%, 33%, 30%, 25%, 20%, 15%, 10%, 5% or 1%. Preferably the cross is less than or equal to 33%. In various other examples, the inter-electrode distance is greater than or equal to 3 mm, greater than or equal to 5 mm, greater than or equal to 10 mm, or greater than or equal to 25 mm.

### Example 6: Additional Features for Alkaline and PEM Electrolyzers

These results demonstrate new and unexpected features for alkaline and PEM electrolyzers. These features can be applied in example electrochemical cells as described herein, including but not limited to cells of the types described in WO2013/185170, WO2015/013764, WO2015/013765, WO2015/013766, WO2015/013767, WO2015/085369, and in the Applicant's concurrent International Patent Applications entitled “Electrochemical cell and components thereof capable of operating at high current density” and “Electrochemical cell and components thereof capable of operating at high voltage”, filed on 14 Dec. 2016.

The above results stand in contrast to those reported in the most advanced known high pressure alkaline electrolyzer developed to date (by Avalence LLC as described in WO2013/066331 and on pages 160-161 in the book “Hydrogen Production by Electrolysis”, by A. Godula-Jopek (Wiley-VCH, 2015)). In that electrolyzer, operation was limited both in the current density (at high pressure) that could be applied in an energy efficient way and the fact that increases in pressure led to increasingly impure gases. Whereas, in the system of WO2013/066331 and on pages 160-161 in the book “Hydrogen Production by Electrolysis”, by A. Godula-Jopek (Wiley-VCH, 2015), pressures of greater than 138 bar were unviable due to gas crossover effects, in present examples no such constraints in pressure apply.

In particular, the problem of equalising the differential pressure of the hydrogen and oxygen that are formed across the separator in advanced high pressure alkaline electrolyzers, such as that developed by Avalence LLC and described in WO2013/066331 and on pages 160-161 in the book “Hydrogen Production by Electrolysis”, by A. Godula-Jopek (Wiley-VCH, 2015), has been eliminated. This problem has been eliminated by removing the separator under conditions in which bubble formation is, effectively, also minimised or eliminated completely. In so doing, uncontrolled gas crossover through the separator due to bubbles lodging in the separator is also eliminated.

Moreover, the fact that the problem of equalising the differential pressure of the hydrogen and oxygen was all the more difficult at higher current densities, has also been removed. Instead, progressive increases in the current density at high pressure appear to have the effect of improving and not degrading the gas purity as is the case for conventional cells.

In present example cells, higher current densities at high pressure therefore improve the purities of the gases collected, and do not degrade the gas purities. Additionally, the use of higher current densities does not come at the cost of lower energy efficiencies. When operated in this way, the cell can be substantially more electrically efficiently than comparable conventional cells.

These results therefore also stand in distinct contrast to conventional alkaline and PEM electrolyzers when they are operated at high pressures. Traditional alkaline electrolyzer diaphragms cannot be operated for extended periods of time above ca. 138 bar because at that pressure micro/nano gas bubbles form in the diaphragm, making it porous to gas crossover (according to page 161 in the book “Hydrogen Production by Electrolysis” by A. Godula-Jopek, Wiley-VCH, 2010). Ionomer membranes, like PEM membranes, have better properties in that respect. They have been reported to generate hydrogen, off-the-stack, of up to 350 bar. However, that was only achieved by the use of very thick PEM membranes (500 μm), so that it was accompanied by a severe drop in ion conductivity between the electrodes, causing the maximum possible energy efficiency of the system to fall to ca. 75% (HHV) (according to the presentation for project PD117 in the 2015 Annual Merit Review Proceedings, Hydrogen Production and Delivery, of the US Department of Energy). Cells of the present embodiments, operated at high pressures, are not subject to either of the above constraints.

A fundamental reason for their remarkable properties is the fact that the present example cells operate, effectively, without, or substantially without the formation of gas bubbles in the liquid electrolyte, especially at higher applied pressures. As a result of the absence of bubbles, there is no practical need for a separator between the electrodes to keep the cathode and anode bubbles apart. When the separator is removed, the catholyte and anolyte chambers become one, so that no pressure differential can then exist between the cathode and anode, at least from the pressure applied to the electrolyte.

The absence of bubbles in the liquid electrolyte further means that increasing current densities do not create an increasing electrical resistance with an accompanying diminished energy efficiency, arising from the “bubble overpotential”, “bubble-curtain” and “voidage” effects. For this reason, there is also a reduced requirement to rapidly pump electrolyte around the cell. As a result of these properties, present example cells can generate high pressure gases of high purity, at, optionally, a high current density, and with, optionally, high electrical and energy efficiency, without the need for a gas compressor.

Similar principles apply to the reverse situation, namely: present example fuel cells can utilize high purity gases at high pressure (obtained with or without use of a compressor), at, optionally, a high current density, to thereby, optionally, achieve high electrical and energy efficiency.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

Optional embodiments may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that many modifications, changes, substitutions or alterations will be apparent to those skilled in the art without departing from the scope of the present invention.

1. A method for producing a gas in an electrochemical cell, wherein the electrochemical cell comprises:
a gas-producing electrode; and
a counter electrode, the gas-producing electrode and the counter electrode being separated by an electrolyte, wherein the electrolyte is a liquid electrolyte or a gel electrolyte;
wherein the method comprises:
creating an electrolyte pressure greater than or equal to 10 bar during operation of the electrochemical cell; and
producing the gas at the gas-producing electrode, wherein substantially no bubbles of the gas are formed at the gas-producing electrode.

2. The method of claim 1, including selecting a current density at least partially based on an inter-electrode distance between the electrodes, to produce a Crossover for the electrochemical cell.

3. The method of claim 2, wherein the current density is greater than or equal to 3 mA/cm², the inter-electrode distance is greater than or equal to 1 mm, and the Crossover is less than or equal to 33%.

4. The method of claim 3, wherein the inter-electrode distance is greater than or equal to 3 mm, greater than or equal to 5 mm, greater than or equal to 10 mm, or greater than or equal to 25 mm.

5. The method of any one of claims 1 to 4, wherein there is no ion exchange membrane positioned between the gas-producing electrode and the counter electrode.

6. The method of any one of claims 1 to 4, wherein there is no diaphragm positioned between the gas-producing electrode and the counter electrode.

7. The method of any one of claims 1 to 6, wherein the electrochemical cell is operated without a gas compressor.

8. The method of any one of claims 1 to 7, wherein bubbles of the gas are not formed at the gas-producing electrode.

9. The method of any one of claims 1 to 8, wherein the gas-producing electrode is a gas diffusion electrode and the counter electrode is a gas diffusion electrode.

10. The method of any one of claims 1 to 9, wherein the counter electrode produces a second gas and substantially no bubbles of the second gas are formed at the counter electrode.

11. The method of any one of claims 1 to 10, where the electrolyte pressure is:
greater than or equal to 20 bar,
greater than or equal to 30 bar,
greater than or equal to 40 bar,
greater than or equal to 50 bar,
greater than or equal to 70 bar,
greater than or equal to 80 bar,
greater than or equal to 90 bar,
greater than or equal to 100 bar,
greater than or equal to 200 bar,
greater than or equal to 300 bar,
greater than or equal to 400 bar, or
greater than or equal to 500 bar.

12. The method of any one of claims 1 to 11, wherein the gas-producing electrode produces high purity gas having a purity of greater than or equal to 90%.

13. The method of any one of claims 1 to 11, wherein the gas-producing electrode produces high purity gas having a purity of:
greater than or equal to 95%,
greater than or equal to 97%,
greater than or equal to 99%,
greater than or equal to 99.5%,
greater than or equal to 99.9%, or
greater than or equal to 99.99%.

14. The method of any one of claims 1 to 13, where a current density of the electrochemical cell is:
greater than or equal to 50 mA/cm²,
greater than or equal to 100 mA/cm²,
greater than or equal to 125 mA/cm²,
greater than or equal to 150 mA/cm²,
greater than or equal to 200 mA/cm²,
greater than or equal to 300 mA/cm²,
greater than or equal to 400 mA/cm²,
greater than or equal to 500 mA/cm²,
greater than or equal to 1000 mA/cm²,
greater than or equal to 2000 mA/cm², or
greater than or equal to 3000 mA/cm².

15. The method of any one of claims 1 to 14, wherein the gas-producing electrode and the counter electrode have a wetting pressure of greater than or equal to 0.2 bar.

16. The method of any one of claims 1 to 14, wherein the gas-producing electrode and the counter electrode have a wetting pressure of:
greater than or equal to 0.4 bar,
greater than or equal to 0.6 bar,
greater than or equal to 0.8 bar,
greater than or equal to 1 bar,
greater than or equal to 1.5 bar,
greater than or equal to 2 bar,
greater than or equal to 2.5 bar,
greater than or equal to 3 bar,
greater than or equal to 4 bar, or
greater than or equal to 5 bar.

17. The method of any one of claims 1 to 16, wherein an electrolyte replacement rate is less than 1 replacement of the electrolyte in the electrochemical cell volume every 1 hour.

18. The method of claim 17, wherein the electrolyte replacement rate is:
less than 1 replacement of the electrolyte in the cell volume every 45 minutes,
less than 1 replacement of the electrolyte in the cell volume every 30 minutes,
less than 1 replacement of the electrolyte in the cell volume every 15 minutes,
less than 1 replacement of the electrolyte in the cell volume every 10 minutes,
less than 1 replacement of the electrolyte in the cell volume every 5 minutes,
less than 1 replacement of the electrolyte in the cell volume every 1 minute,
less than 1 replacement of the electrolyte in the cell volume every 30 seconds,
less than 1 replacement of the electrolyte in the cell volume every 5 seconds, or
less than 1 replacement of the electrolyte in the cell volume every 1 second.

19. An electrochemical cell for producing a gas, wherein the electrochemical cell comprises:
a gas-producing electrode; and
a counter electrode, the gas-producing electrode and the counter electrode being separated by an electrolyte, wherein the electrolyte is a liquid electrolyte or a gel electrolyte;
wherein there is no diaphragm or ion exchange membrane positioned between the gas-producing electrode and the counter electrode; and
wherein the electrochemical cell operates at an electrolyte pressure greater than or equal to 10 bar and substantially no bubbles of the gas are formed at the gas-producing electrode.

20. The electrochemical cell of claim 19, wherein the electrochemical does not use a gas compressor.

21. The electrochemical cell of claim 19 or 20, wherein the gas-producing electrode is a gas diffusion electrode.

22. The electrochemical cell of any one of claims 19 to 21, wherein the counter electrode is a gas diffusion electrode.

23. The method of any one of claims 19 to 22, wherein a current density is greater than or equal to 3 mA/cm², an inter-electrode distance is greater than or equal to 1 mm, and a Crossover is less than or equal to 33%.

24. The method of claim 23, wherein the inter-electrode distance is greater than or equal to 3 mm, greater than or equal to 5 mm, greater than or equal to 10 mm, or greater than or equal to 25 mm.
